(19) United States
(12) Patent Application Publication
(10) Pub. No.: US 2014/0097566 A1
(43) Pub. Date: Apr. 10, 2014

(54) CUTTING BOARD ASSEMBLY

(71) Applicant: Daliana Rivera, Aberdeen, MD (US)

(72) Inventor: Daliana Rivera, Aberdeen, MD (US)

(73) Assignee: ELITE REVOLUTIONARY SOLUTIONS, LLC, Abingdon, MD (US)

(21) Appl. No.: 13/857,765

(22) Filed: Apr. 5, 2013

Related U.S. Application Data
(60) Provisional application No. 61/621,393, filed on Apr. 6, 2012.

(51) Int. Cl. A47J 47/00; A47J 47/16

(52) U.S. Cl. CPC A47J 47/005; A47J 47/16
USPC 269/16; 248/304; 248/205.1

(57) ABSTRACT

The present invention provides cutting board assemblies for food preparation. The devices of the invention can be used for cutting food, storing food, and transport cut food items. The devices of the invention include removable food containment trays with lids. The devices of the invention can also include at least one storage drawer for knives or food. Also provided are cutting board holders and space saver for being mounted under a kitchen cabinet, on walls, or on pantry doors.

### CROSS-REFERENCE TO RELATED APPLICATIONS

This application claims benefit of priority under 35 U.S.C. §119(e) of U.S. Ser. No. 61/621,393, filed Apr. 6, 2012, the entire contents of which are incorporated herein by reference in their entireties.

### BACKGROUND OF THE INVENTION

1. Field of the Invention

This invention relates generally to the field of food preparation and more specifically to cutting surface devices for chopping or slicing of food as well as storing cutting boards.

2. Background Information

Preparation of food can be greatly facilitated with properly designed devices. Cutting boards have been used extensively in modern kitchens. There are at least four major advantages for using a cutting board device in a kitchen. First, the use of a cutting board can protect permanent surfaces in a kitchen. Second, the use of a portable cutting board enables the actions of cutting and chopping to be performed in different areas of a kitchen. Third, the use of a cutting board can facilitate in transferring or transporting food items within a kitchen. Forth, a cutting board can be easily cleaned after food preparation. However, food items often drop from traditional cutting boards with only one flat surface in the absence of any particular mechanism to contain food items during food preparation. In addition, knives or blades are often stored at a different place than cutting boards, making food preparation in certain places difficult or inconvenient, for example, outdoor cooking.

Thus, there is a need for a cutting board device and cutting board storage devices that can take full advantages of transferring food and providing storage for knives.

### SUMMARY OF INVENTION

The present invention provides cutting board assemblies for food preparation. The devices of the invention can be used for cutting food, storing food, and/or transport cut food items. The devices of the invention may include removable food containment trays. The devices of the invention can also include at least one storage drawer for knives. Also provided are cutting board holders which can be mounted on a wall, a cabinet door or pantry door, and a space saver for being mounted under a kitchen cabinet.

The cutting board kit of the invention may include a main unit capable of connecting to two or more removable food containment trays using a magnet-metal plate mechanism and a design to allow the containers to snap into the cutting board side walls. The removable trays, which optionally have lids, can be easily detached from the main unit allowing a user to transport cut food items, for example, into a cooking pan or pot. The main unit includes a cutting board and optionally includes at least one knife storage drawer. A cutting board holder is also provided for allowing ease of locating cutting board and knives stored therein. The cutting boards may be removed from the cutting board holder at the time desired by the user.

In one embodiment, the present invention is related to a food preparation device, comprising one main unit and at least two removable food containment trays. In one aspect, the removable food containment trays are with removable plastic, machine washable lids. In another aspect, the main unit further comprising a flat cutting surface and at least two magnets on its sides. In another aspect, each of the at least two removable food containment trays further comprising at least a metal plate on its side. In another aspect, the removable food containment trays can be secured on the sides of the main unit via the magnet-metal plate interaction as well as the design of the side of the cutting board to snap in to the sides of the main unit of the cutting board. In another aspect, the food preparation device comprises four removable food containment trays and all four trays have removable, dishwasher safe, plastic lids.

In one aspect, the removable food containment trays are made of plastic. In another aspect, the removable food containment trays can snap into the main unit/cutting board and have at least one metal plate which meets with a magnet or magnetic plate on the main unit/cutting board. In another aspect, the food preparation device of the invention comprises two removable food containment trays. In an additional aspect, these two removable food containment trays can snap into left side, and right side of the main unit. In another aspect, the main unit further comprises one groove on the cutting surface where it is close to its front edge. In an alternative aspect, the main unit further comprises a groove on the cutting surface close to its back edge.

In an alternative aspect, the main unit comprises at least three removable food containment trays. In one aspect, the main unit comprises four removable food containment trays. In an additional aspect, all four removable food containment trays can be secured on the sides of the main unit via the magnet-metal plate interaction. In one aspect, the main unit further comprises a groove close to its front edge.

In one aspect, the food preparation device further comprises at least one knife or food drawer. In an addition aspect, the food preparation device comprises two knife or food drawers. In another aspect, the knife or food drawer has at least one magnet or magnetic plate. In an additional aspect, the magnet of magnetic plate of the knife or food drawer will not be visible. In another aspect, the knife or food drawer comprises a molded-in handle.

In another aspect, the main units comprises at least one housing having grooves to allow the at least one knife or food drawer to slide in. In another aspect, the knife or food drawer comprises a plural of reverse grooves or rails that go into grooves inside the housing of the main unit to allow it to slide in place and back out.

In one aspect, the food preparation device further comprises a cutting board holder. In another aspect, the cutting board holder can be mounted on a wall, a door, or cabinet door. In another aspect, the cutting board holder comprises at least four holes on the backboard of the holder to put screws through them for mounting.

In one embodiment, the present invention is related to a cutting board holder comprising one large flat surface, one small flat surface, and a bottom surface. In one aspect, both the large flat surface and the small flat surface are connected to the bottom surface.

In one aspect, the cutting board holder can be mounted on a wall. In another aspect, the cutting board holder can be mounted inside pantry doors. In another aspect, the cutting board holder is made of wood. In another aspect, the cutting board holder is made of plastic.

In another embodiment, the present invention is related to a cutting board holder. The cutting board holder includes three vertical surfaces and two horizontal surfaces. In one aspect, the cutting board holder includes a housing which can accommodate at least three cutting boards. In another aspect, the cutting board holder includes a housing which can accommodate at least five cutting boards. In one aspect, one vertical surface of the cutting board holder includes loading springs for holding cutting boards in place. In another aspect, the left and right, vertical, side walls have grooves in them to allow the boards to slide into the housing in place.

In another embodiment, the present invention is related to a space saver device to be mounted under a cabinet/cupboard, comprising two brackets, one flat horizontal surface and two vertical surfaces that have a bracket with holes to allow screws to attach to the cabinet/cupboard. In one aspect, the flat horizontal surface is connected to the two vertical surfaces. In another aspect, each of the vertical surfaces is connected to each of the brackets.

In another embodiment, the present invention provides a food preparation device comprising one main unit and at least one removable food containment tray. The main unit includes a flat cutting surface, a front portion and a back portion, and a plurality of magnets, magnet plates, or metal plates; and each removable food containment tray comprises a magnet, metal plate, or magnetic plate, and optional comprises a lid to cover storing space; wherein each removable food containment tray is secured to the main unit via a magnet-metal plate interaction.

In one aspect, the main unit further comprises a groove on the cutting surface proximate to the front portion. In another aspect, the main unit further comprises two grooves on the cutting surface, wherein one groove is proximate to the front portion and the other groove is proximate to the back portion. In another aspect, the device comprises two removable food containment trays. In another aspect, the device comprises four removable food containment trays.

In another embodiment, the present invention provides a food preparation device comprising one main unit and at least one knife drawer or food drawer. In one aspect, the knife drawer or food drawer comprises at least one magnet or magnetic plate. In another aspect, the knife drawer or food drawer comprises a plurality of reverse grooves or rails.

In another embodiment, the present invention provides a cutting board holder comprising a plurality of grooves for holding a plurality of cutting boards, optionally further comprising load springs for securing the cutting boards. In one aspect, the cutting board holder can hold five cutting board. In another aspect, the cutting board can hold at least three cutting board.

In various aspects, the magnet, magnetic plate, or metal plate of the devices described herein may have a round or circular shape, rectangle shape, or squared shape.

### BRIEF DESCRIPTION OF THE DRAWINGS

For more complete understanding of the features and advantages of the present invention, reference is now made to the detailed description of the invention along with the accompanying figures, wherein:

FIG. 1 shows an exemplary food preparation device of the invention with two removable food containment trays attached.

FIG. 2 shows a front view of an exemplary food preparation device of the invention. Two attached removable food containment trays are shown.

FIG. 3 shows a bottom perspective view of an exemplary food preparation device of the invention. Four legs are shown.

FIG. 4 shows a main unit of an exemplary food preparation device of the invention. FIG. 4A shows a side view of the main unit. FIG. 4B shows a perspective view of the main unit.

FIG. 5 shows perspective views of an exemplary removable food containment tray of the invention. The lid for the removable food containment tray is also shown.

FIG. 6 shows a main unit of another exemplary food preparation device of the invention. The main unit shown here includes a housing for a knife or food drawer of the invention.

FIG. 7 shows a main unit of another exemplary food preparation device of the invention. The main unit shown here includes two housings for two knife or food drawers of the invention.

FIG. 8 shows an exemplary knife or food drawer of the invention from two different views.

FIG. 9 shows an exemplary food preparation device of the invention with two knife or food drawers in retracted position.

FIG. 10 shows an exemplary food preparation device of the invention with four removable food containment trays attached.

FIG. 11 shows a perspective view of an exemplary food preparation device of the invention with four removable food containment trays attached.

FIG. 12 shows two different views of an exemplary removable food containment tray of the invention.

FIG. 13 shows an exemplary cutting board holder of the invention. Grooves for the housing to store cutting boards are shown.

FIG. 14 shows another exemplary cutting board holder of the invention. Three stored cutting boards are shown.

FIG. 15 shows a front view of another exemplary cutting board holder of the invention.

FIG. 16 shows a perspective view of the cutting board holder of FIG. 15.

FIG. 17 shows another exemplary cutting board holder of the invention, where two cutting board holders are linked as one device.

FIG. 18 shows an exemplary space saver of the invention. FIG. 18A shows a front view of the space saver attached to a kitchen cabinet. FIG. 18B shows a bottom view of the space saver attached to a kitchen cabinet.

FIG. 19A shows another exemplary cutting board holder of the invention. Grooves for the housing to store cutting boards are shown. No springs are provided at the back of the cutting board holder. This particular cutting board holder can hold five cutting boards.

FIG. 19B and FIG. 19C shows two different views of another exemplary cutting board holder of the invention. This cutting board holder can hold an additional cutting board on its top portion where an opening on the top panel can hold a cutting board.

FIG. 20 shows an exemplary cutting board of the invention with one removable food containment tray attached.

FIG. 21A shows an exemplary cutting board of the invention without removable food containment trays attached, where the back of the cutting board comprises four magnets or magnetic plates (round or circular) for attaching removable food containment trays of the invention. FIG. 21B shows a side view for the cutting board. The sides of the cutting board also comprise two magnets or magnetic plates (round or circular) for attaching removable food containment trays of the invention.

FIG. 22 shows an exemplary removable food containment tray of the invention, where a metal strip/plate or magnetic strip/plate is shown in FIG. 22A. Also a lid for the removable food containment tray is shown in FIG. 22B.

FIG. 23 shows another exemplary cutting board of the invention. FIG. 23A shows a view from the bottom side of the cutting board with one removable food containment tray attached. FIG. 23B shows a side view of the cutting board without a removable food containment tray attached, where three magnets or magnetic plates (round or circular) are visible.

FIG. 24 shows another exemplary cutting board of the invention without removable food containment trays attached. FIG. 24A shows an isometric view of the cutting board having rectangle magnets or magnetic plates for attaching removable food containment trays are visible. FIG. 24B shows a front view of the cutting board. FIG. 24C shows part of the front view of the cutting board where a removable food containment tray can be attached on the side.

FIG. 25 shows another exemplary removable food containment tray of the invention, where a metal strip/plate or magnetic strip/plate is visible in FIG. 25A. Also a lid for the removable food containment tray is shown in FIG. 25B.

FIG. 26 shows another exemplary cutting board of the invention with four removable food containment trays attached.

FIG. 27 shows additional exemplary removable food containment trays of the invention. FIG. 27A shows isometric views of food containment trays. FIG. 27B shows isometric views of food containment trays. FIG. 27C shows isometric views of food containment trays. FIG. 27D shows isometric views of food containment trays. FIG. 27E shows an isometric view of a food containment tray. FIG. 27F shows an isometric view of a food containment tray. FIG. 27G shows an isometric view of a food containment tray. These removable food containment trays can be used for attaching to the cutting board shown in FIG. 10, 11, 20, 21, or 26.

FIG. 28 shows another exemplary cutting board holder in the vertical position with an optional holder, where the housing is facing front. FIG. 29 further shows the optional holder without the cutting board holder in place.

FIG. 30 shows another exemplary cutting board holder in the vertical position where the housing is facing up. This cutting board holder can also optionally have a stand.

FIG. 31 shows another exemplary cutting board of the invention, where the cutting surface extends into a ridge over its back portion. FIG. 31A shows a perspective front view of the cutting board. FIG. 31B shows a top view of the cutting board. FIG. 31C shows a side view of the cutting board.

FIG. 32 shows another exemplary cutting board of the invention.

FIG. 33 shows another exemplary cutting board of the invention.

FIG. 34 shows a front perspective view of the cutting board of FIG. 32.

FIG. 35 shows a side perspective view of the cutting board of FIG. 32.

FIG. 36 shows a bottom view of the cutting board of FIG. 32.

FIG. 37 shows another exemplary cutting board of the invention having an arced front.

FIG. 38 shows a side perspective view of the cutting board of FIG. 37.

FIG. 39 shows a bottom view of the cutting board of FIG. 37.

FIG. 40 shows another exemplary cutting board of the invention.

FIG. 41 shows a front perspective view of the cutting board of FIG. 40.

FIG. 42 shows a bottom view of the cutting board of FIG. 40.

FIG. 43 shows another exemplary cutting board of the invention having a removable food containment tray.

FIG. 44 shows an expanded view of the removable food containment tray and magnetic attachment to the cutting board of FIG. 43.

FIG. 45 shows another exemplary cutting board of the invention having 2 removable food containment trays.

FIG. 46 shows another exemplary cutting board of the invention having dual drawers.

FIG. 47 shows a top perspective view of the cutting board of FIG. 46.

FIG. 48 shows a front perspective view of the cutting board of FIG. 46

FIG. 49 shows a bottom view of the cutting board of FIG. 46.

### DETAILED DESCRIPTION OF THE INVENTION

It is an object of the invention to produce a device for cutting food, storing knives therein, holding/transporting cut food, and providing a way to store the cutting boards. Accordingly, the invention includes a combination food cutting, knife storing, and food transporting.

It is another object of the invention to provide a device for conveniently removing peelings and shredding from a cutting board. Accordingly, the invention includes at least one removable drawer which can be easily detached and re-attached to the cutting board.

To accomplish the above and related objects the invention, the drawings are used to illustrate exemplary embodiments of the invention. These drawings are illustrative only.

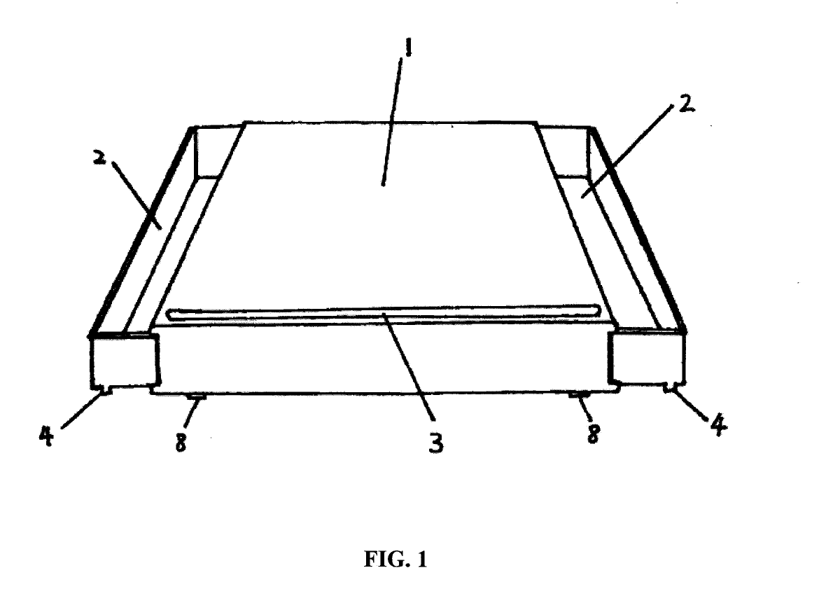

Referring to FIG. 1, there is illustrated a main unit (1) of an exemplary food preparation device of the invention. Two exemplary removable food containment trays (2) are shown one the left side and right side of the main unit (1) and the removable food containment trays (2) have a step-up bar (4) at their bottoms. The step-up bar (4) can also be useful for a user to hold or grip the removable food containment tray (2). Also shown is an optional groove (3) on the cutting surface close to the front edge of the main unit (1).

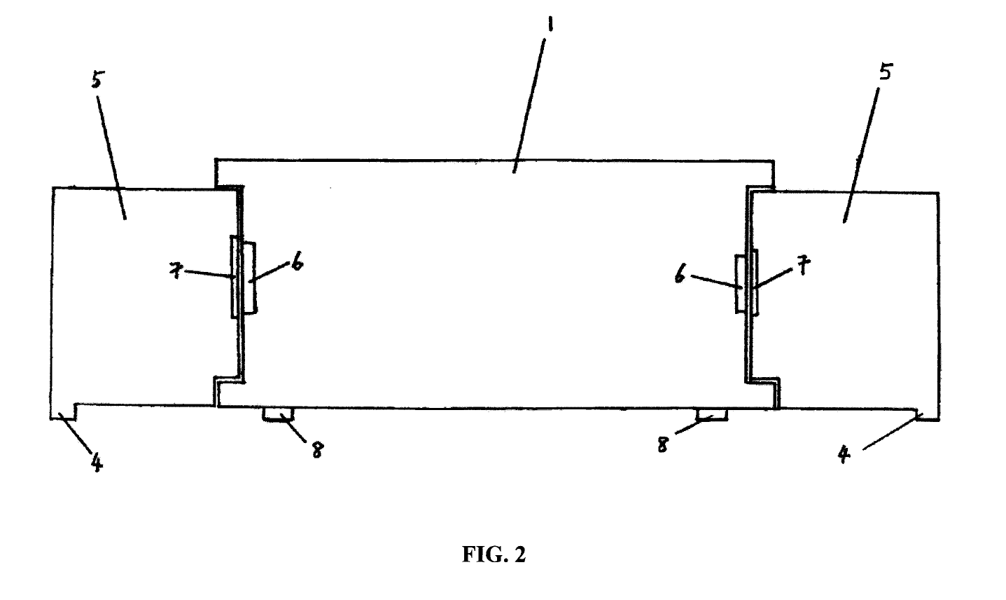

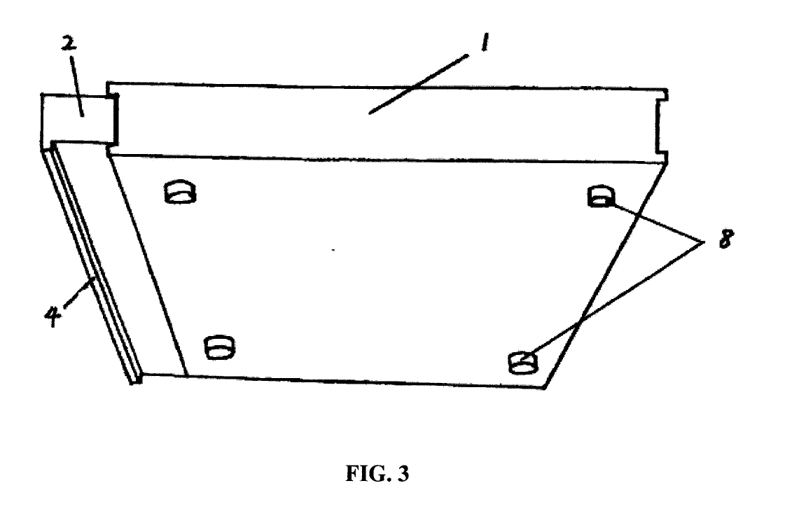

FIG. 2 shows a front view of the main unit (1) with two exemplary removable food containment trays (5) attached. The step-up bars (4) of the removable food containment trays (5) are illustrated. Also shown are magnets or magnetic plates (6) on the main unit and metal plates (7) on the removable food containment trays (5). The removable food containment trays (5) are attached to the main unit (1) via magnet-metal plate interaction, where magnets (6) are located on the sides of the main unit (1), and metal plates (7) are located on the connecting sides of the removable food containment trays. Legs (8) are also shown.

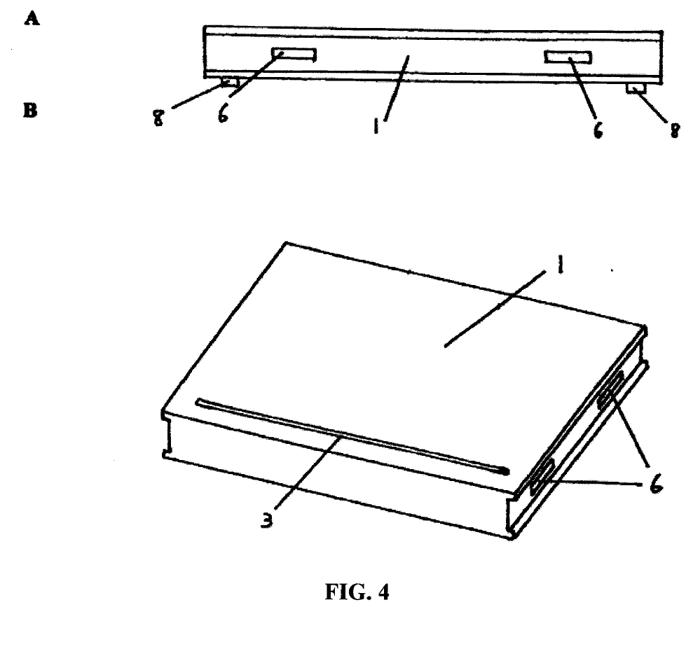

FIG. 3 shows a bottom perspective view of the main unit (1) with one removable food containment tray (2) detached. Legs (8) are shown at each corner of the unit which can provide supporting function for the main unit (1), leaving a space between the main unit and a kitchen surface including a countertop. Such a space can prevent liquid to be trapped between the main unit (1) and a kitchen surface. The step-up bar (4) of the removable food containment tray (2) also has the function to prevent liquid to be trapped between the removable food containment tray (2) and a kitchen surface.

FIG. 4 shows additional views of the main unit (1) with removable food containment trays detached. FIG. 4A shows a side view of the main unit (1) where the magnets or magnetic plates (6) and legs (8) are visible for illustrative purpose. In some embodiments, the magnets or magnetic plates (6) are covered by the material of the main unit, for example, plastic or wood, and are not visible to naked eyes. In other embodiments, the magnets or magnetic plates (6) are exposed and visible to naked eyes. FIG. 4B shows a perspective view where the magnets or magnetic plates (6) are visible for illustrative purpose when the removable food containment trays are detached. Also shown is an optional groove (3) on the cutting surface close to the front edge of the main unit (1).

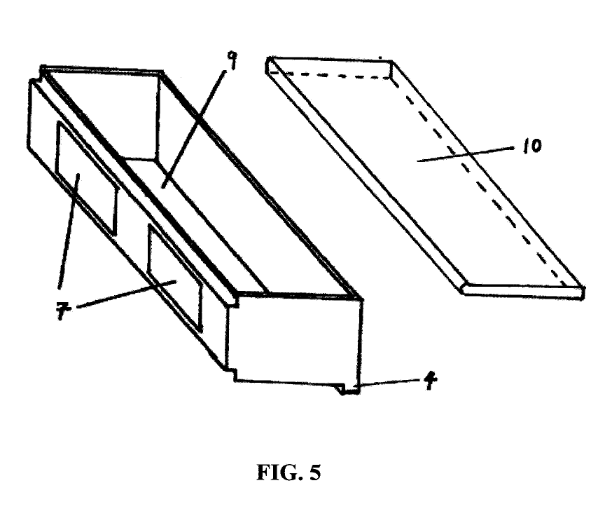

FIG. 5 shows an exemplary removable food containment tray (9) where metal plates or magnetic plates (7) are visible for illustrative purpose when the removable food containment tray (9) is detached from the main unit. In some embodiments, the metal plates or magnetic plates (7) are covered by the material of the main unit, for example, plastic or wood, and are not visible to naked eyes. In other embodiments, the metal plates or magnetic plates (7) are exposed and visible to naked eyes. Also illustrated is the step-up bar (4) of the removable food containment tray (9). The lid (10) for the removable food containment tray is also illustrated.

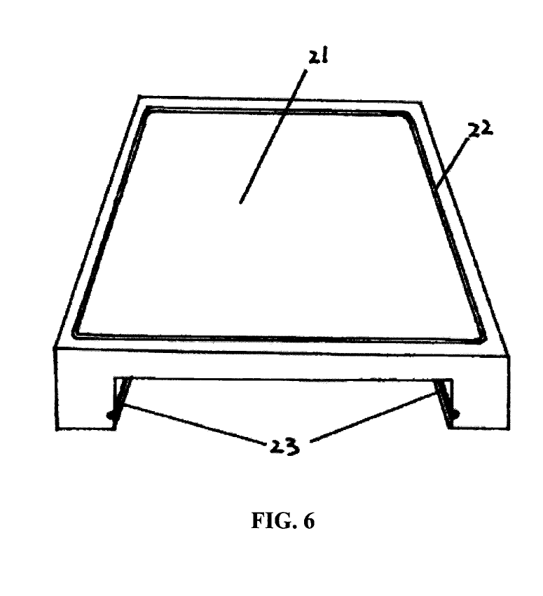

FIG. 6 shows a main unit (21) of another exemplary food preparation device of the invention. A groove (22) on the cutting surface close to the edges of the main unit (21) is shown. Also shown is a housing at the front of the main unit (21) for a knife or food drawer of the invention. Two grooves (23) on the sides of the housing are shown for the knife storage drawer to slide into the housing space.

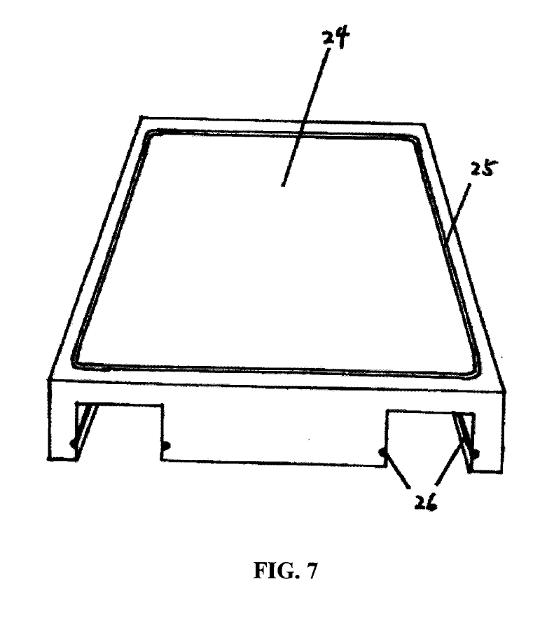

FIG. 7 shows another main unit (24) of another exemplary food preparation device of the invention. A groove (25) on the cutting surface close to the edges of the main unit (24) is shown. Also shown are two housings at the front of the main unit (24) for two knife or food drawers of the invention. Four grooves (26) on the sides of the housings are shown for two knife or food drawers to slide into the housing spaces.

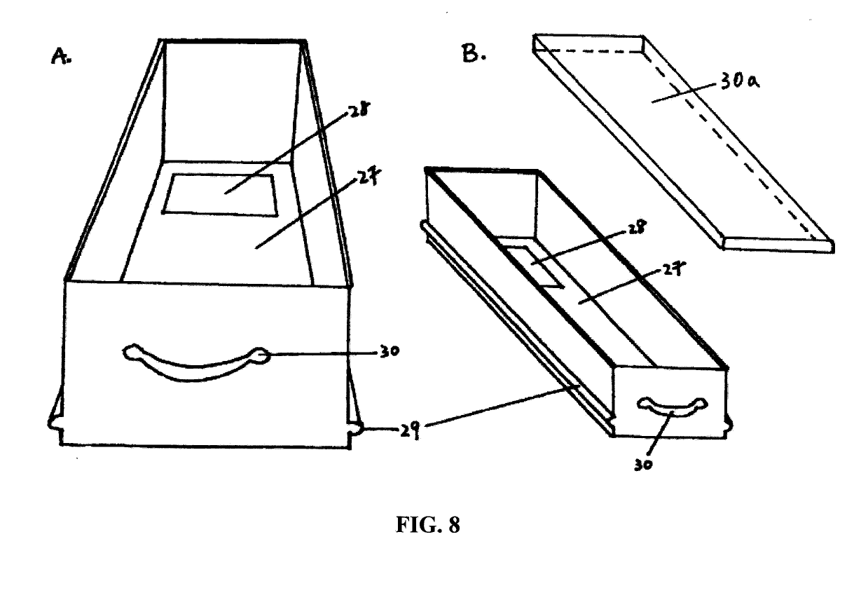

FIG. 8 shows two different views of an exemplary knife or food drawer (27), including a magnet or magnetic plate (28) for securing knives in the drawer and a handle (30). Reverse grooves or rails (29) are for inserting into grooves (26) of the main unit (24). A lid (30a) for the knife or food drawer is also shown.

Cutting boards of the main unit (1), (21), or (24) may be made of any suitable materials known in the art, including molded polymers such as polyethylene (including high density polyethylene) and acrylics as well as wood, metal (including stainless steel), glass, plastic, resin, or other materials. Cutting boards of the main unit (1), (21), or (24) may also have a variety of surfaces and surface configurations that may be suited to or enhance operations in preparation of one or more foodstuffs, including smooth or rough surfaces. Similarly, the removable food containment trays (2), (9), and knife or food drawers (27) can be made of the same or different materials from the main unit (1), (21), or (24).

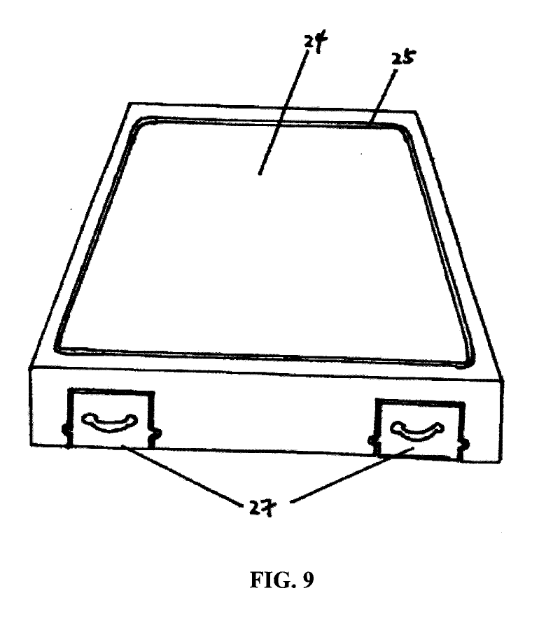

FIG. 9 shows an exemplary cutting board holder of the invention where two knife or food drawers (27) are in their retracted position. The main unit (24) comprises a groove (25) close to its hour edges.

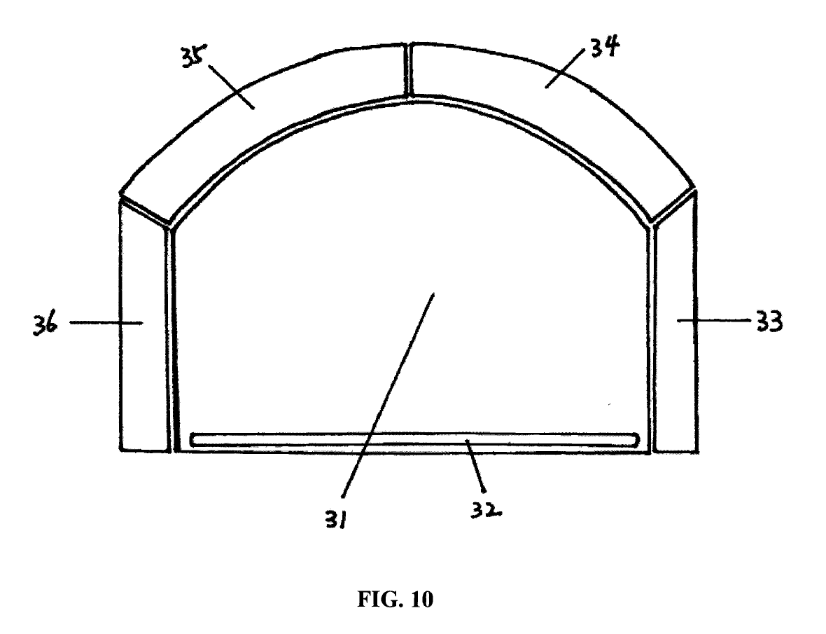

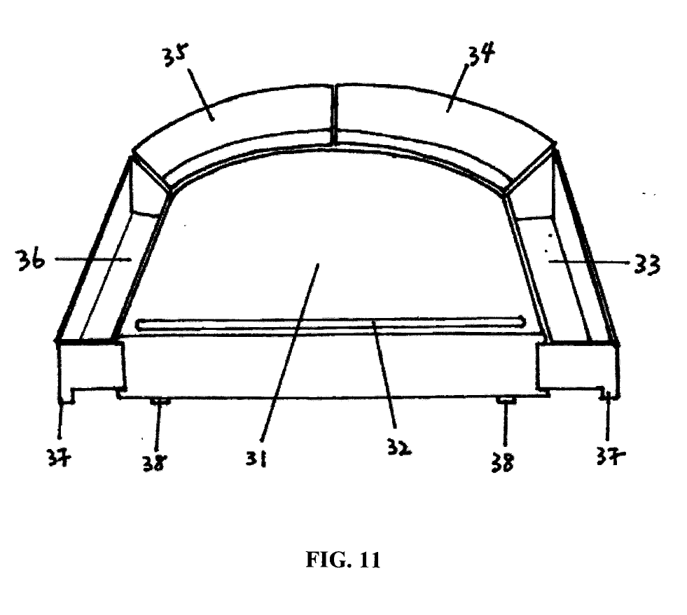

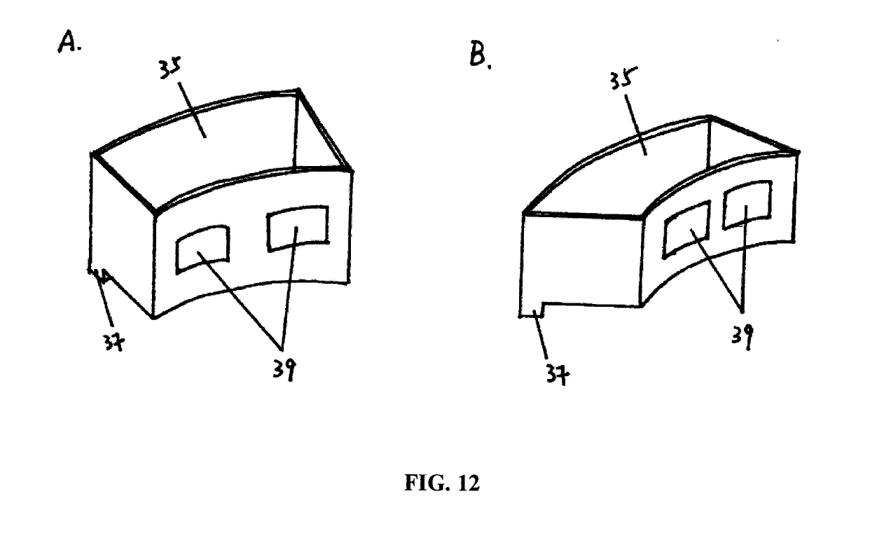

FIG. 10 shows a top view of an exemplary food preparation device of the invention where four removable food containment trays (33), (34), (35), and (36) are attached to the main unit (31). The main unit (31) comprises a groove (32) on the cutting surface close to its front edge. FIG. 11 shows a perspective view of the same food preparation device of the invention, where step-up bars (37) of the removable food containment tray and legs (38) are also shown. FIGS. 12A and 12B show additional views for one of the four removable food containment trays (35), where step-up bars (37) and metal plates or magnetic plates (39) [for attaching to the main unit (31)] are shown.

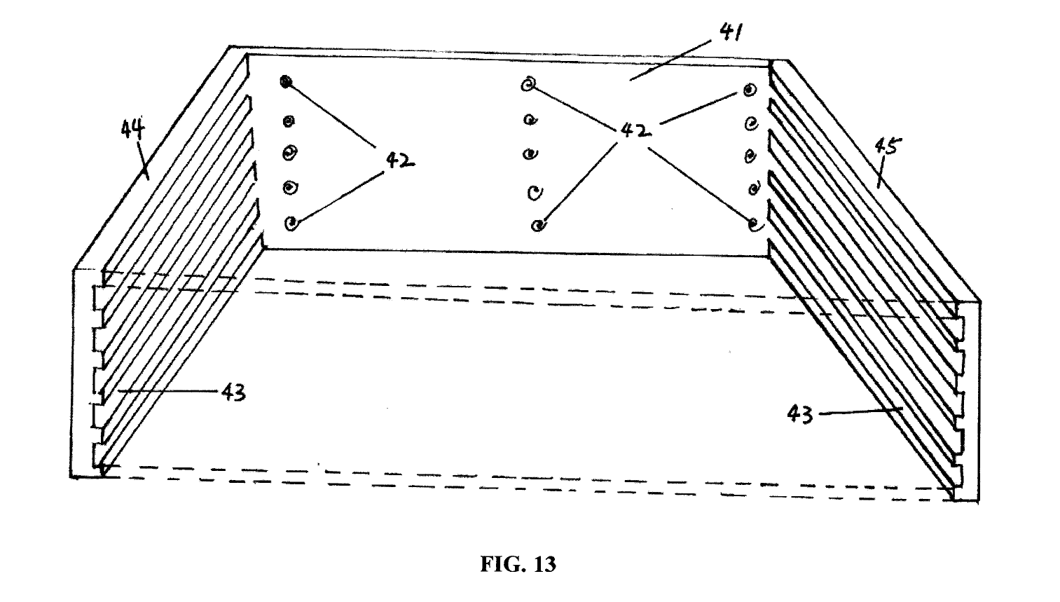

FIG. 13 shows an exemplary cutting board holder (41) of the invention where grooves (43) for storing cutting boards are shown. The back panel (41) is connected to the left panel (44) and right panel (45) to form a housing for storing the cutting boards. Loading springs (42) are used to secure the cutting board in place.

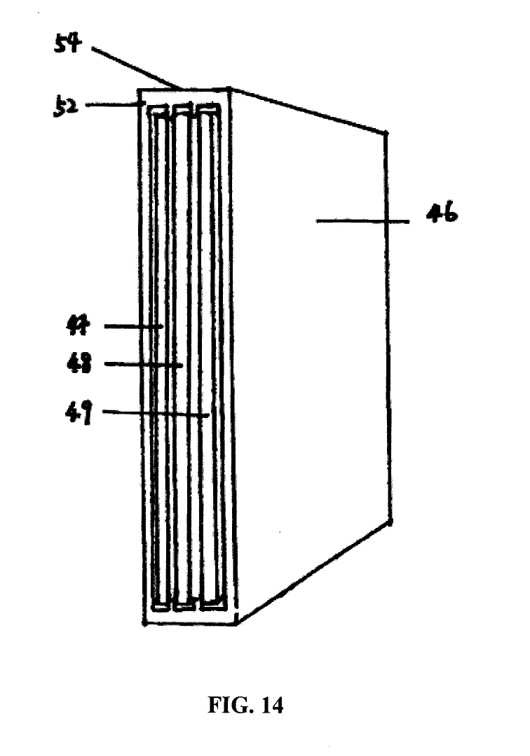

FIG. 14 shows another exemplary cutting board holder (52) of the invention where three cutting boards (47), (48), and (49) are stored. The vertical surfaces (46) and horizontal surfaces (54) are connected to form a housing for storing the cutting boards.

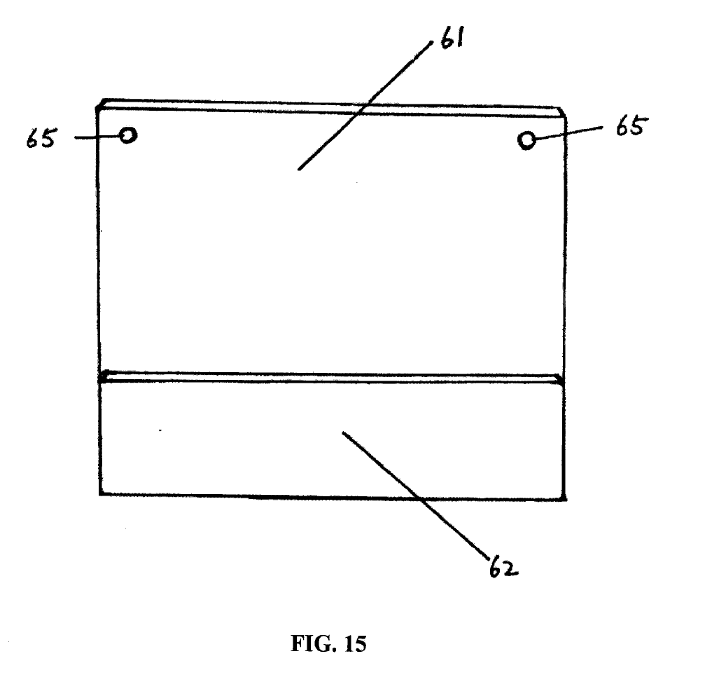

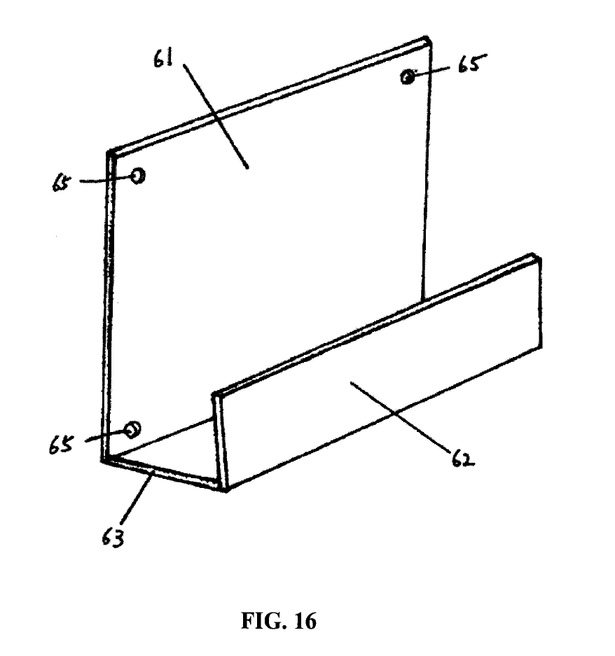

FIG. 15 shows a front view of another exemplary cutting board holder of the invention, where a large flat surface (61) at the back, a small flat surface (62) at the front are shown. Also shown are holes (65) for mounting on a wall or a pantry door. FIG. 16 shows a perspective view of the same cutting board holder of the invention, where a large flat surface (61) at the back, a small flat surface (62) at the front are shown. Also shown are holes (65) for mounting on a wall or a pantry door.

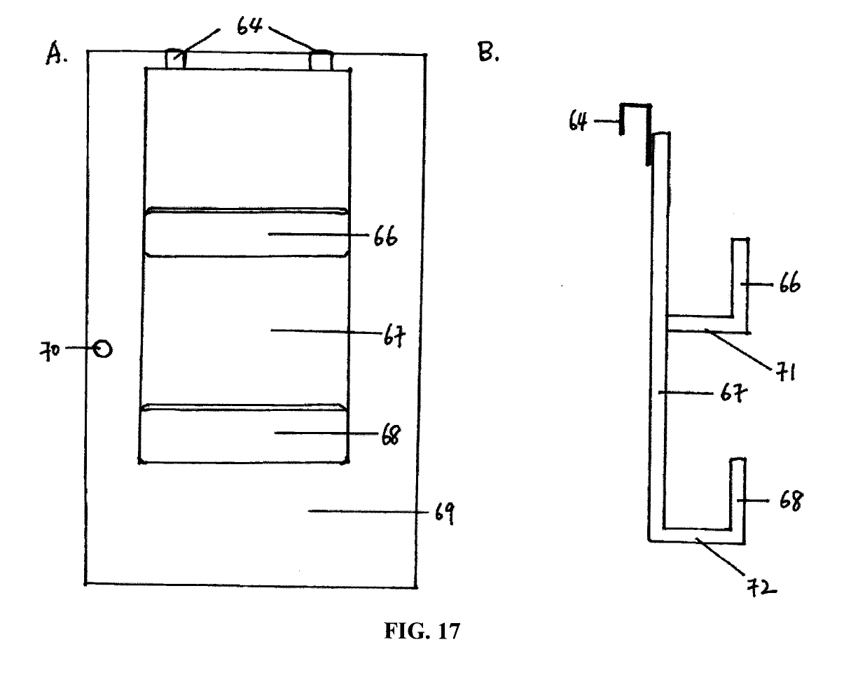

FIG. 17 shows another exemplary cutting board holder of the invention, where two cutting board holders are linked as one device. Hooks (64) are used for hanging over a door (69) with a door handle (70). The cutting board holder has one large vertical surface (67) and two small vertical surfaces (66) and (68). Horizontal surfaces (71) and (72) are connected to the vertical surfaces to form housing for the cutting boards.

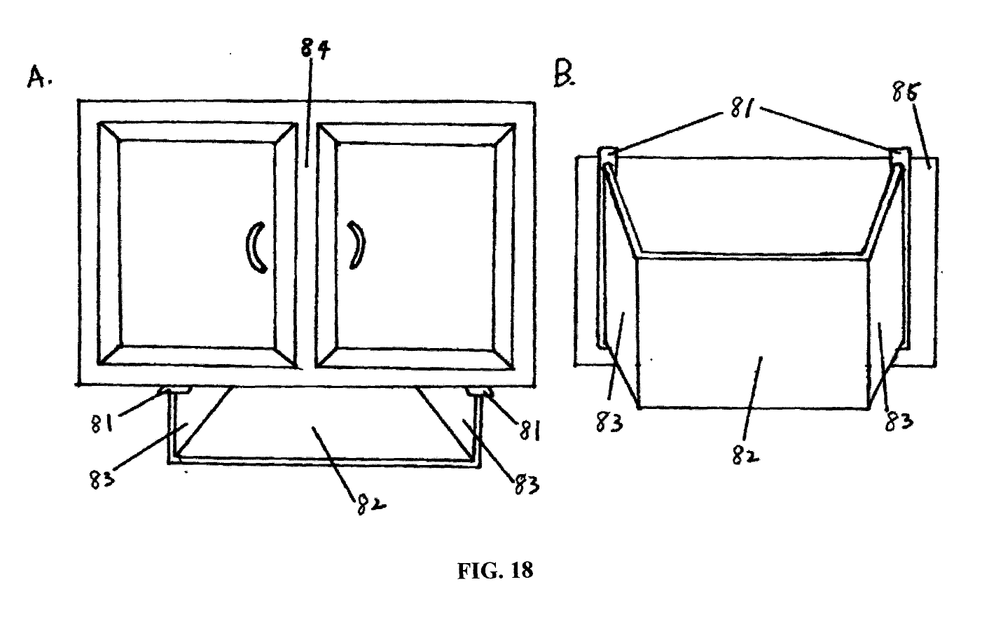

FIG. 18 shows a space saver of the invention. FIG. 18A shows a front view of the space saver mounted under a kitchen cabinet (84). The space saver includes two brackets (81), two vertical surfaces (83) and one horizontal surface (82). FIG. 18B shows a bottom perspective view of the space saver mounted under a kitchen cabinet. The bottom of the cabinet (85) is visible, as well as the brackets with two holes, one at each end to secure with screws (81), vertical surfaces (83) and horizontal surface (82). The space saver can be made of wood or any other suitable materials known in the art.

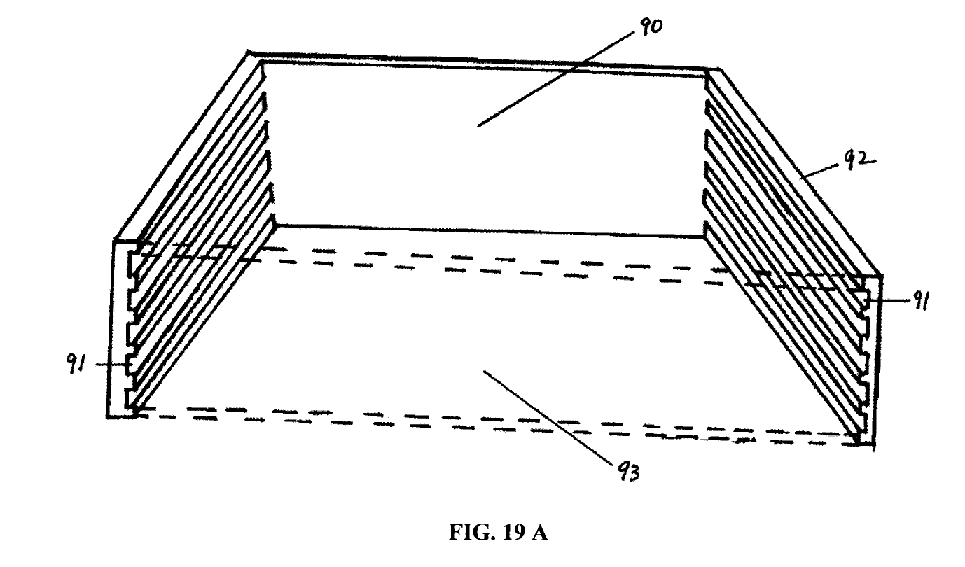

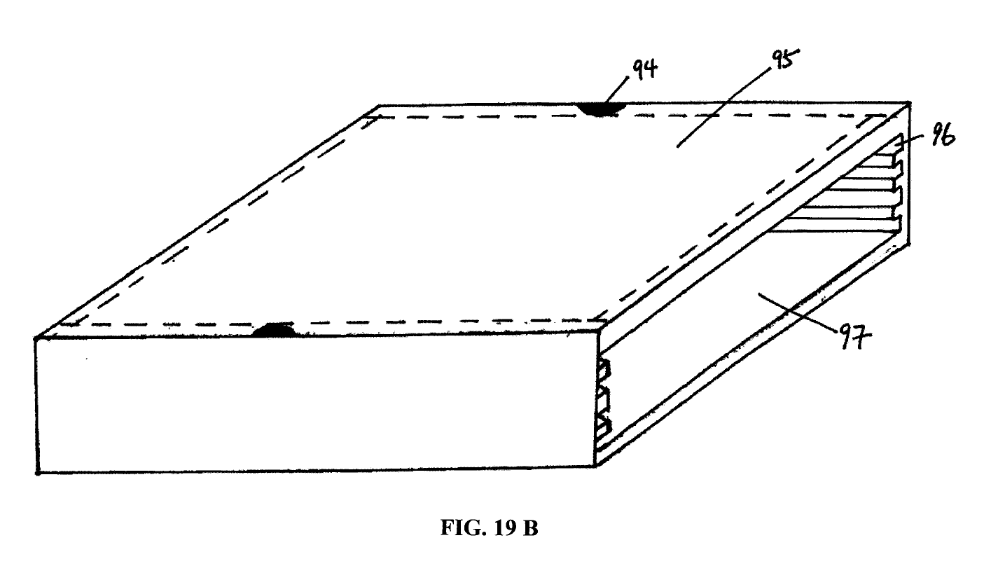

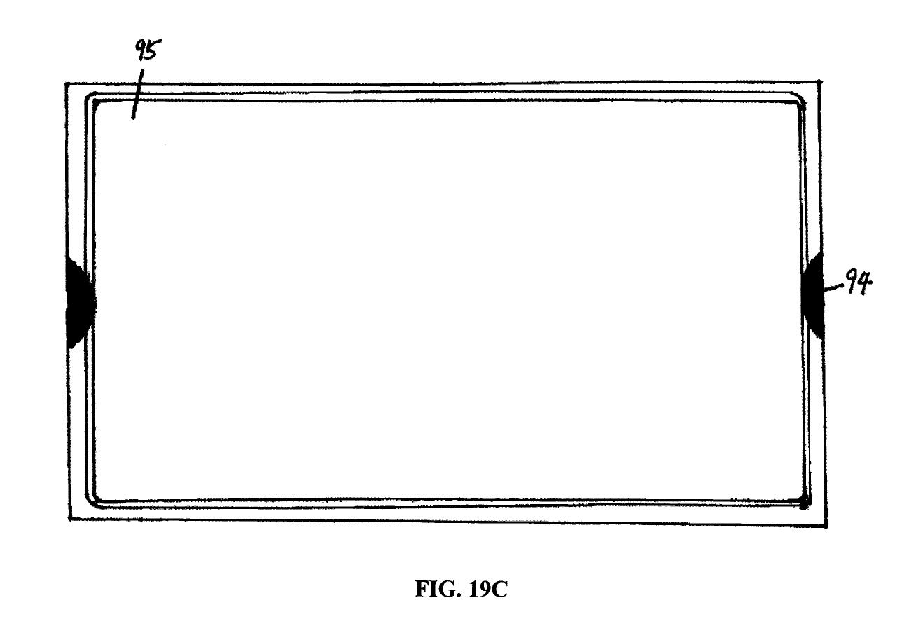

FIG. 19A shows another exemplary cutting board holder of the invention. Grooves (91) for the housing to store cutting boards are shown on the side panels (92) of the cutting board holder. No springs are provided at the back (90) of this cutting board holder, and this particular cutting board holder can hold five cutting boards. The dashed lines shows the front opening (93) of the cutting board holder for demonstration of the grooves (91) without obstruction of view.

FIG. 19B another exemplary cutting board holder of the invention. A cutting board (95) fits onto the top portion of the cutting board holder, and grooves (94) facilitate removal of the top cutting board (95). Grooves (96) for the housing to store cutting boards are visible from the housing (97) of the cutting board holder for storing cutting boards. This cutting board holder can hold one cutting board on the top portion and four cutting board in its housing, for a total of five cutting boards. FIG. 19C shows top view of this cutting board holder, where the grooves (94) and the top cutting board (95) are visible.

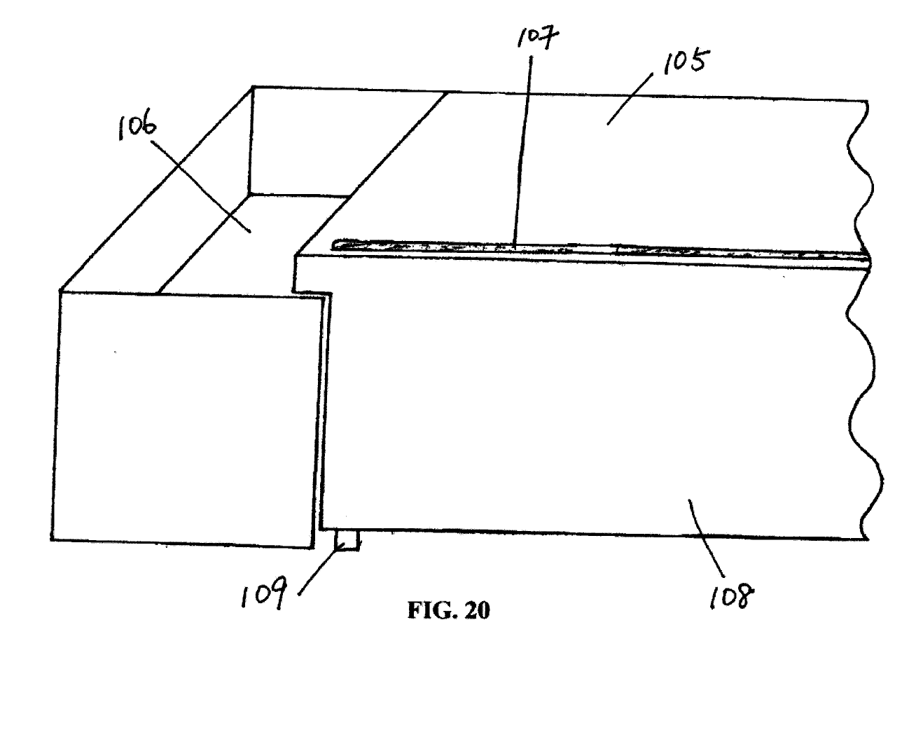

FIG. 20 shows an exemplary cutting board of the invention. The cutting surface (105) has an optional groove (107) close to its front portion (108) for storing excess liquid during food processing. The leg (109) and the attached removable food containment tray (106) are shown.

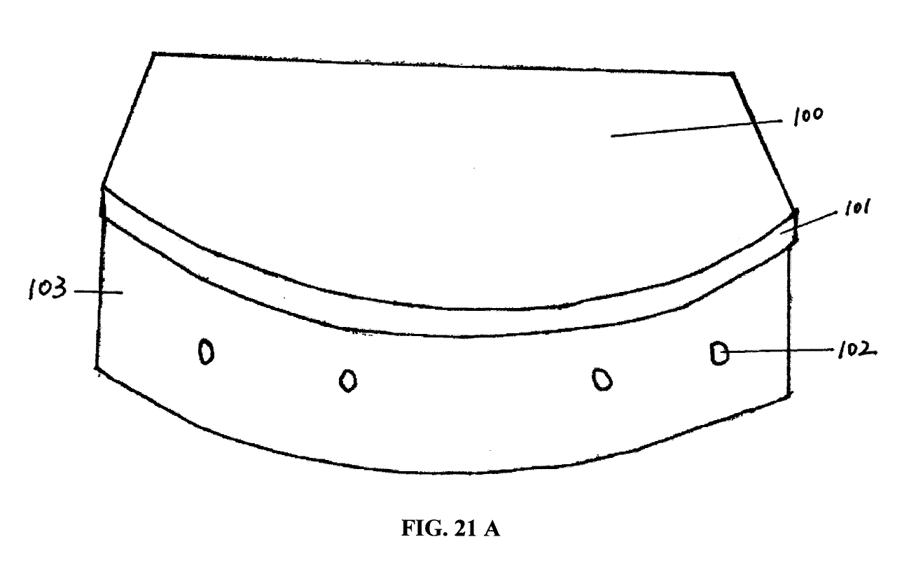

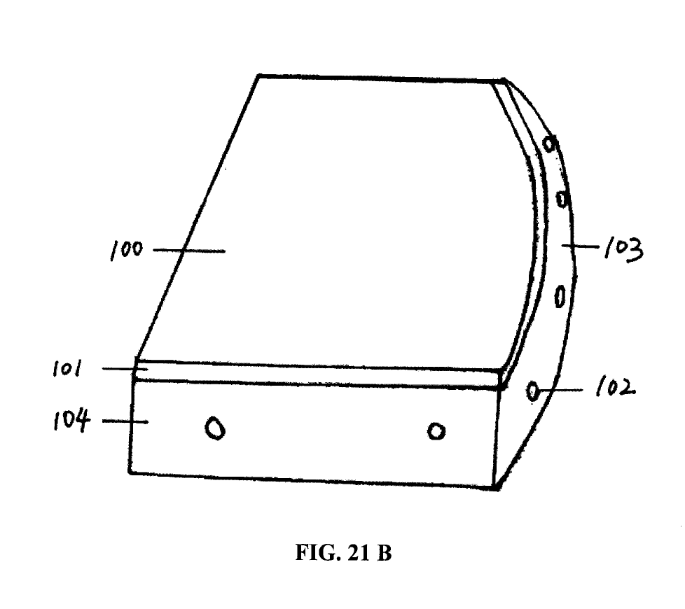

FIG. 21A shows an exemplary cutting board of the invention without removable food containment trays attached, where the back (103) of the cutting board comprises four magnets or magnetic plates (round or circular) (102) for attaching removable food containment trays of the invention. The cutting surface (100) and the edge (101) for allowing the containers to snap into the cutting board side walls are shown. FIG. 21 B shows a side view for the cutting board. The sides (104) of the cutting board also comprises two magnets or magnetic plates (round or circular) (102) for attaching removable food containment trays of the invention.

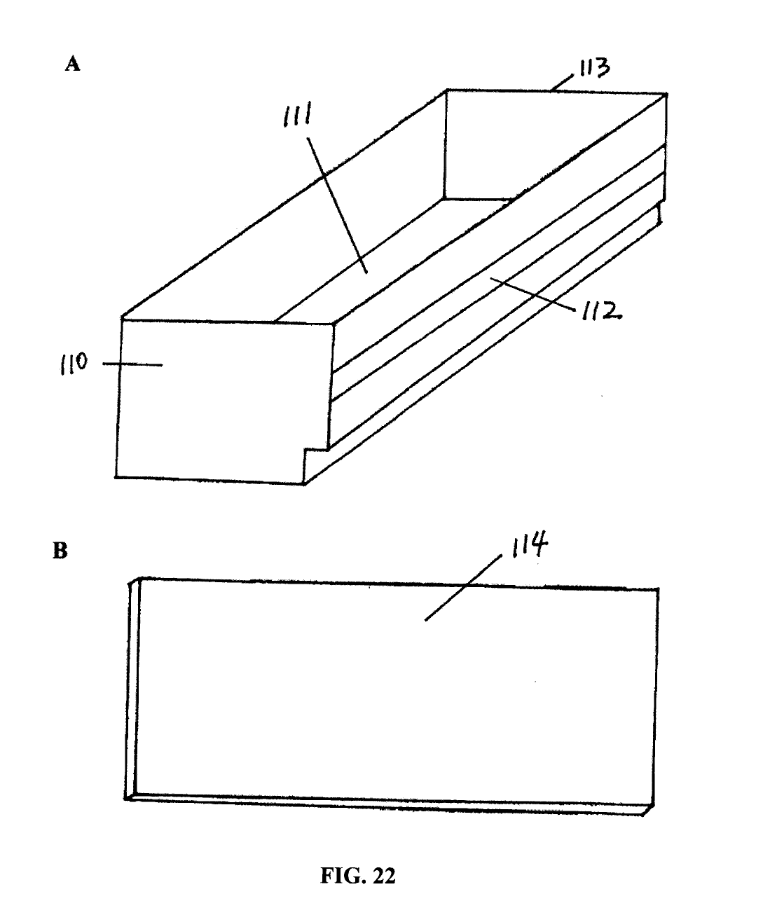

FIG. 22 shows an exemplary removable food containment tray of the invention, where a metal strip/plate or magnetic strip/plate (112) is shown in FIG. 22A. The front portion (110) and the storing portion (111) of the removable food containment tray are shown. Also a lid (114) for the removable food containment tray is shown in FIG. 22B. The lid (114) can fit onto the top portion (113) of the removable food containment tray.

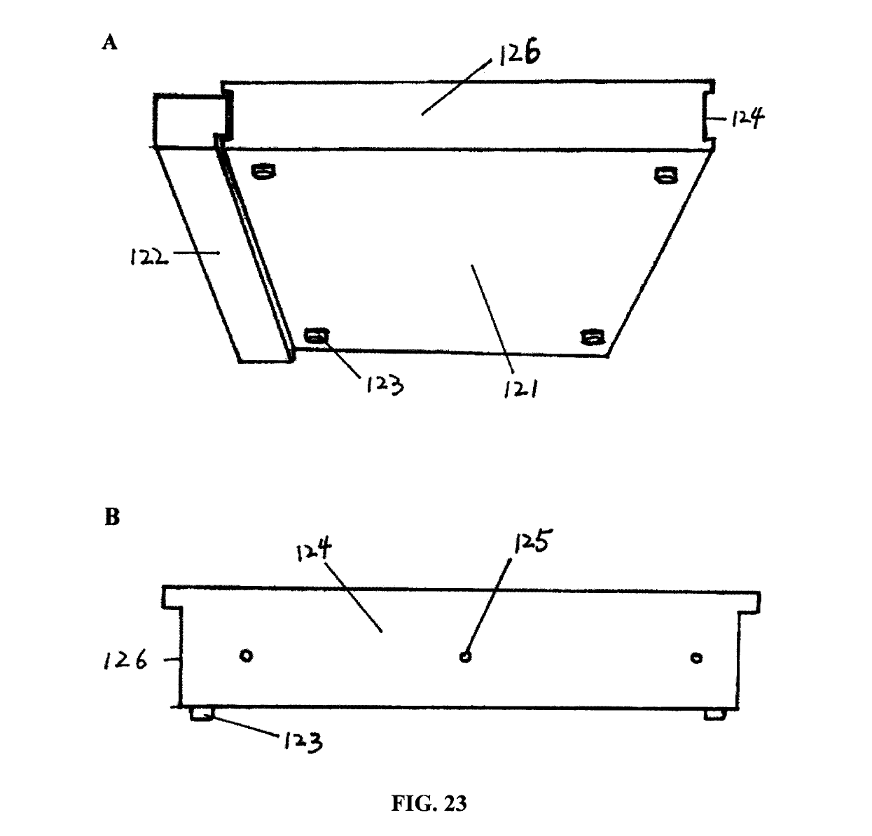

FIG. 23 shows another exemplary cutting board of the invention. FIG. 23A shows a view from the bottom side (121) of the cutting board with one removable food containment tray (122) attached. This cutting board has four legs (123). The front portion (126) and a side (124) without a removable food containment tray attached are also illustrated. FIG. 23B shows a side (124) view of the cutting board without a removable food containment tray attached, where three magnets or magnetic plates (round or circular) (125) and legs (123) are visible.

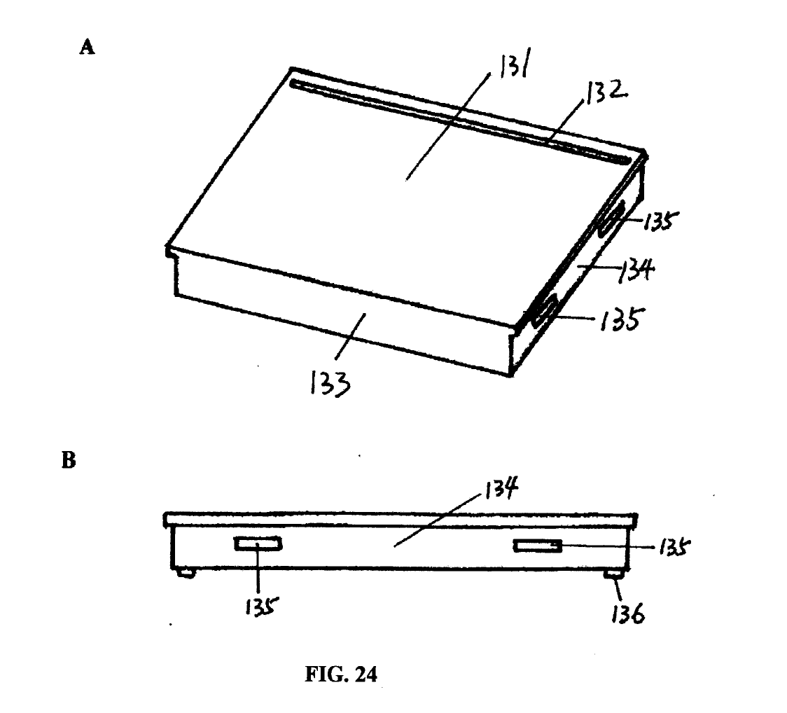

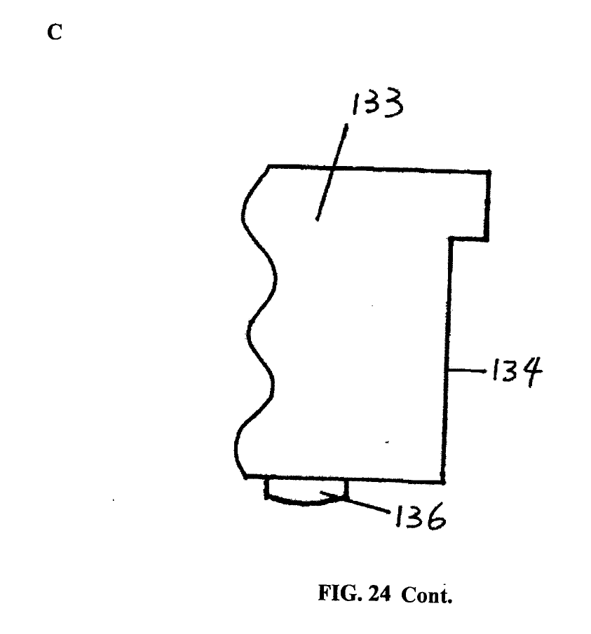

FIG. 24 shows another exemplary cutting board of the invention without removable food containment trays attached. Rectangle magnets or magnetic plates (135) on a side (134) for attaching removable food containment trays are visible in FIG. 24A. Also shown is an optional groove (132) on the cutting surface close to the front edge of the cutting surface (131). FIG. 24B shows a side (134) view of the cutting board wherein legs (136) and magnets, magnetic plates, or metal plates (135) are visible. FIG. 24C shows part of the front (133) view of the cutting board where a removable food containment tray can be attached on the side (134).

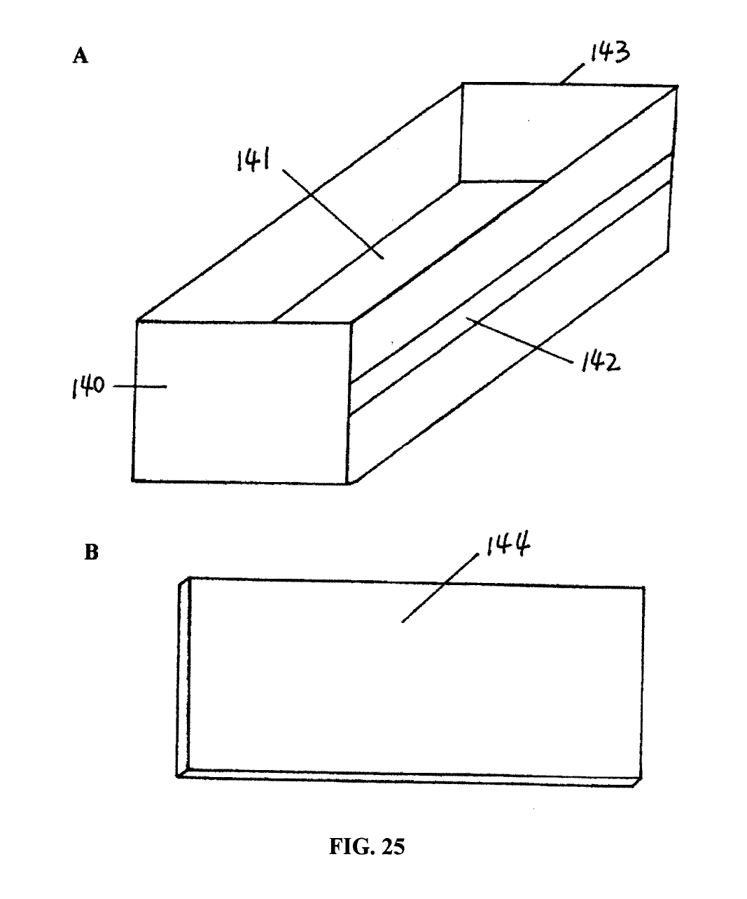

FIG. 25 shows another exemplary removable food containment tray of the invention, where a metal strip/plate or magnetic strip/plate (142) is visible in FIG. 25A. The front portion (140) and the storing portion (141) of the removable food containment tray are shown. Also a lid (144) for the removable food containment tray is shown in FIG. 25B. The lid (144) can fit onto the top portion (143) of the removable food containment tray.

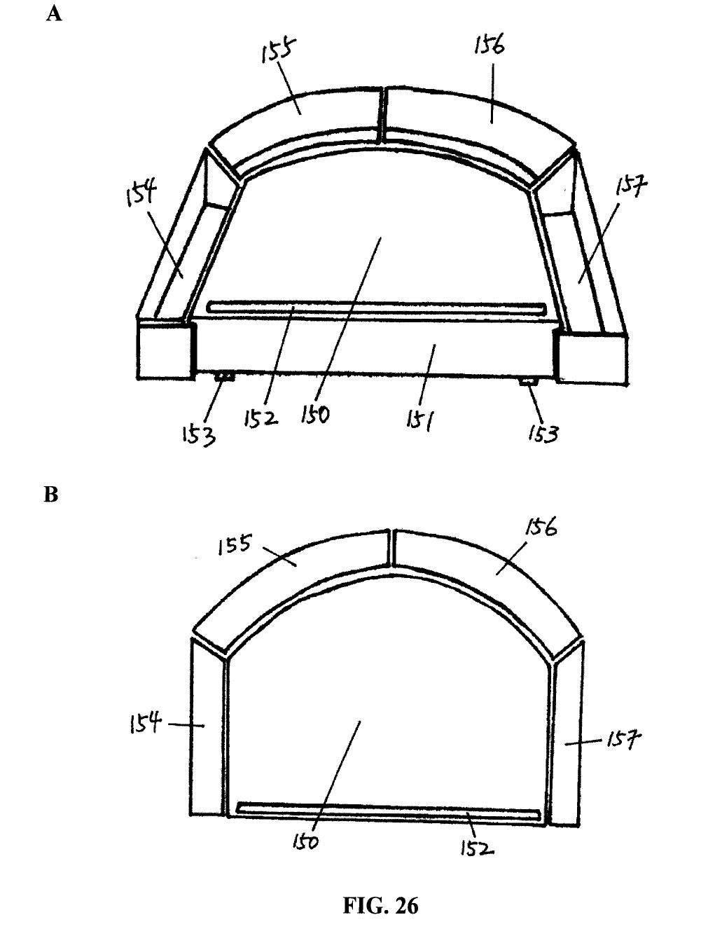

FIG. 26 shows another exemplary cutting board of the invention with four removable food containment trays (154, 155, 156, and 157) attached. The cutting surface (150), a groove (152) close to the front portion (151) and legs (153) are visible in FIG. 26A. The groove (152) has a function of storing excess liquid when food is processed or cut on the cutting surface (150). FIG. 26B shows a top view of the cutting board.

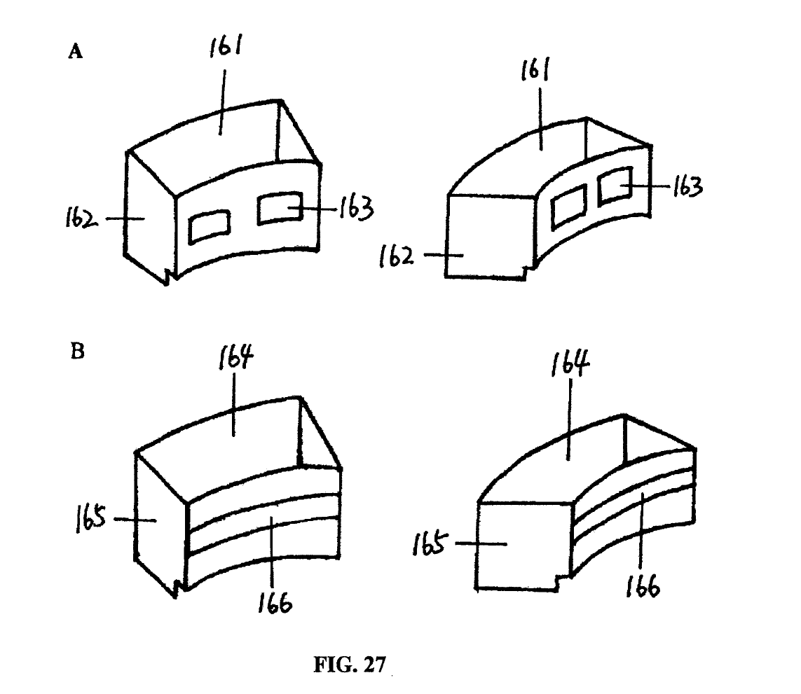

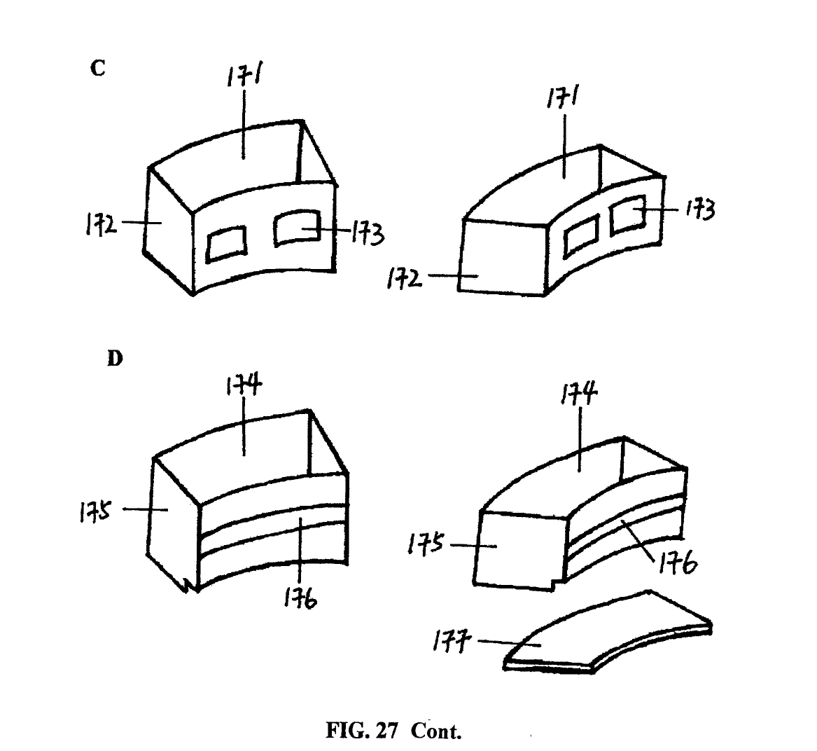

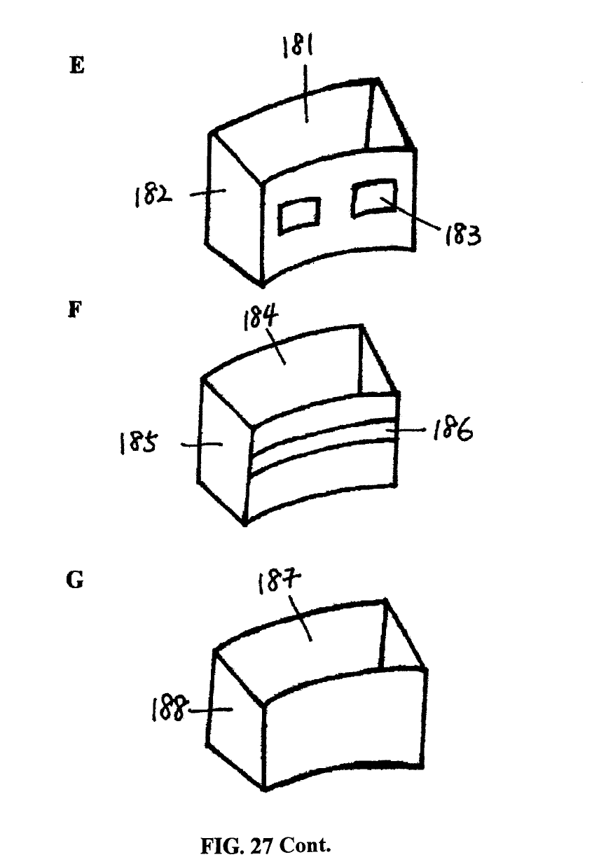

FIG. 27 shows additional exemplary removable food containment trays of the invention. These removable food containment trays can be used for attaching to the cutting board shown in FIG. 10, 11, 20, 21, or 26. FIG. 27A shows two views of a removable food containment tray of the invention with two rectangle metal plates or magnetic plates (163). FIG. 27B shows two views of another removable food containment tray of the invention with a metal strip/plate or magnetic strip/plate (166).

FIG. 27C shows two views of another removable food containment tray of the invention with two rectangle metal plates or magnetic plates (173). FIG. 27B shows two views of another removable food containment tray of the invention with a metal strip/plate or magnetic strip/plate (176). A lid (177) is also shown in FIG. 27D, where the lid (177) can cover the storing space (174) of the removable food containment tray.

FIG. 27E shows another removable food containment tray with two rectangle metal plates or magnetic plates (183). FIG. 27F shows another removable food containment tray of the invention with a metal strip/plate or magnetic strip/plate (186). FIG. 27G shows another removable food containment tray of the invention without a metal strip/plate or magnetic strip/plate. These removable food containment trays can optionally have lids.

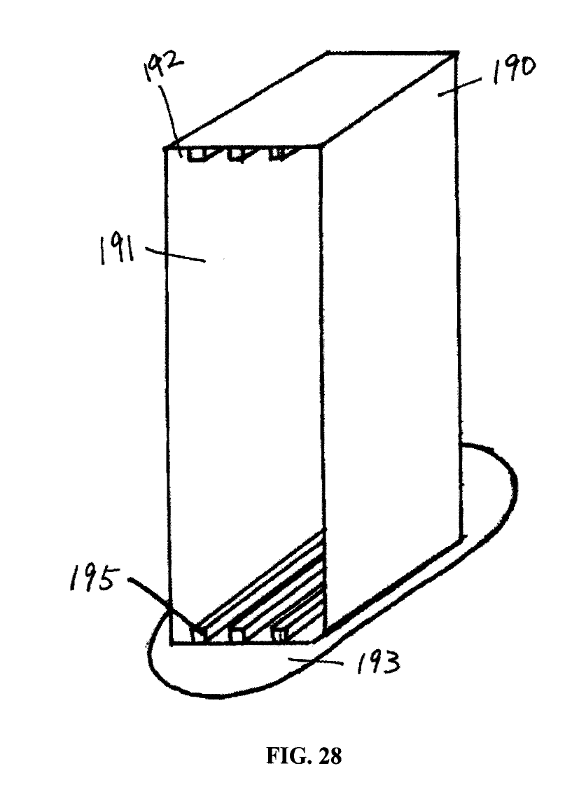

FIG. 28 shows another exemplary cutting board holder (190) of the invention in vertical position, where the housing (191) is facing front. The housing (191) can hold four cutting boards in the vertical position. Grooves (192) and ridges (195) for holding the cutting boards are shown. This cutting board has a stand (193). FIG. 29 shows additional views of the stand (193) without the cutting board holder in place. The cutting board hold fits in the stand housing (194) of the stand (193).

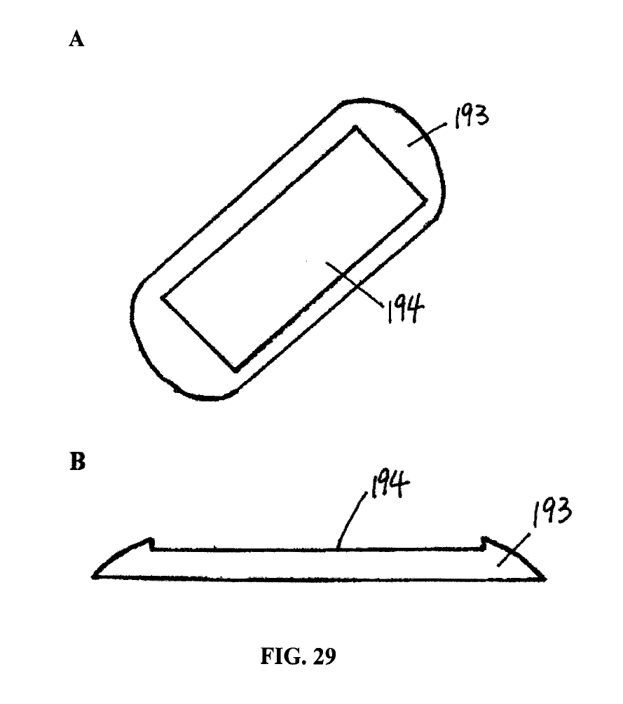

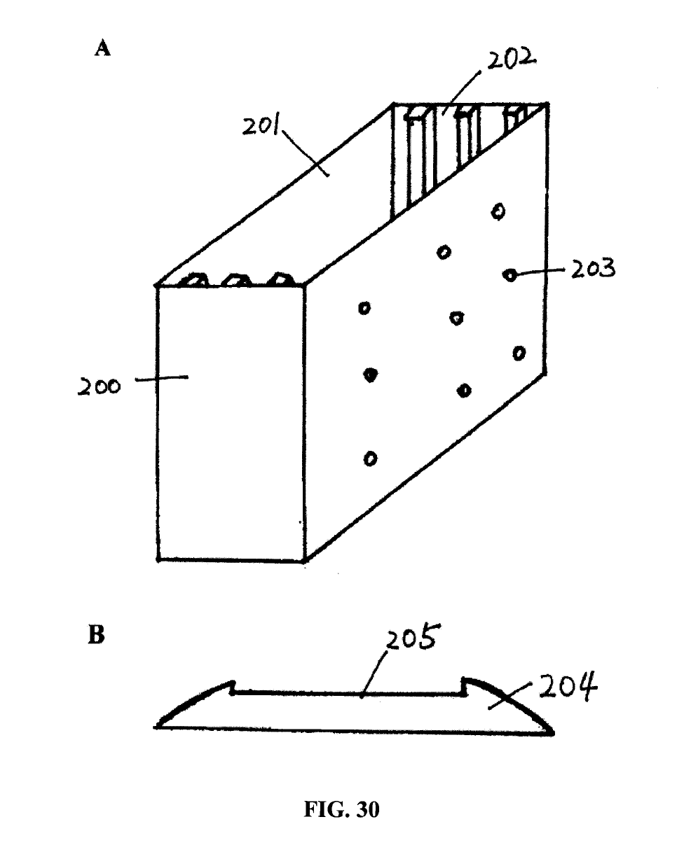

FIG. 30 shows another exemplary cutting board holder (200) of the invention also in vertical position but the housing (201) is facing up (i.e., the opening is at the top). The housing (201) can hold four cutting boards in the vertical position. Grooves (202) for holding the cutting boards and optional vent pores (203) for facilitating drying on the cutting boards are shown. This cutting board can also have a stand (204), where the cutting board hold fits in the stand housing (205) of the stand (204).

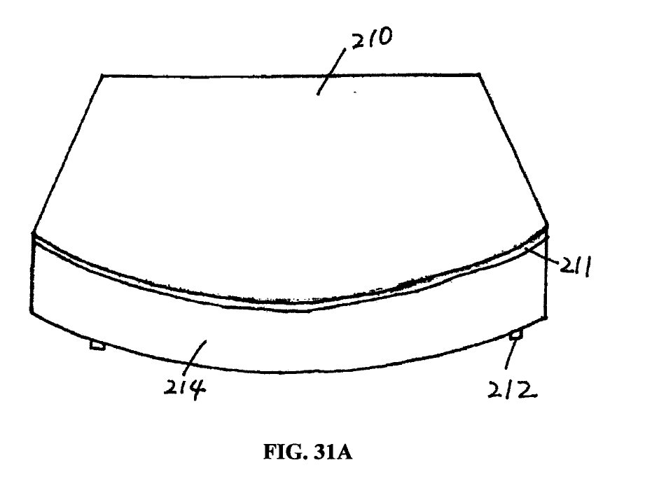

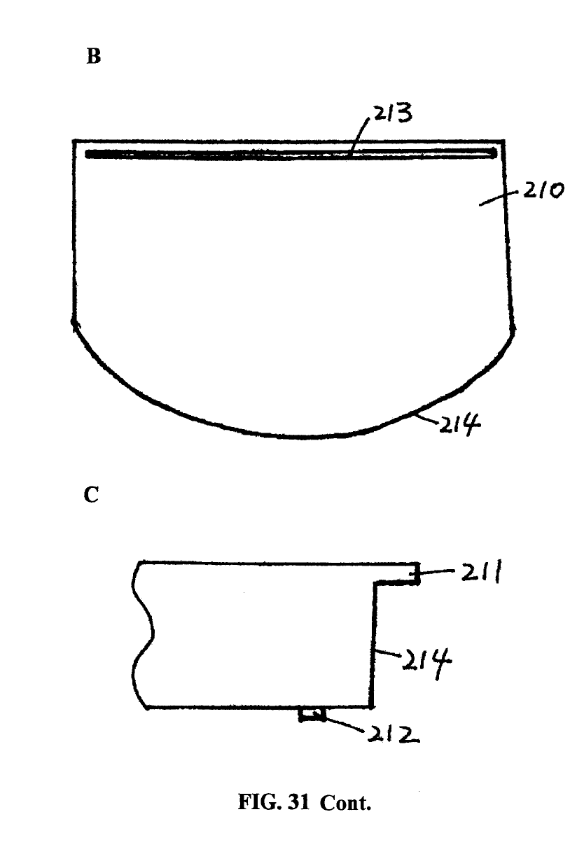

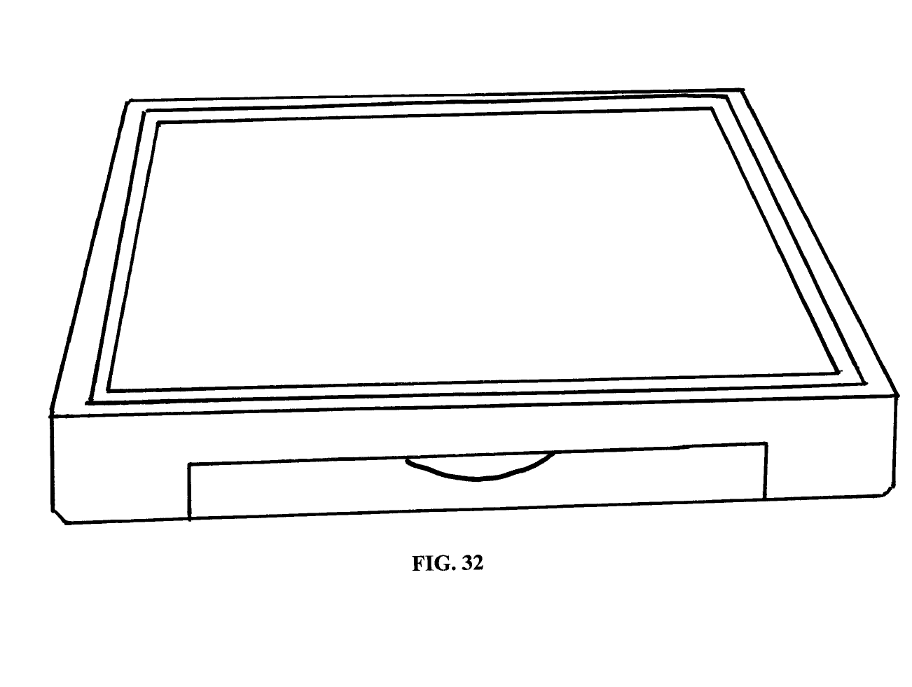

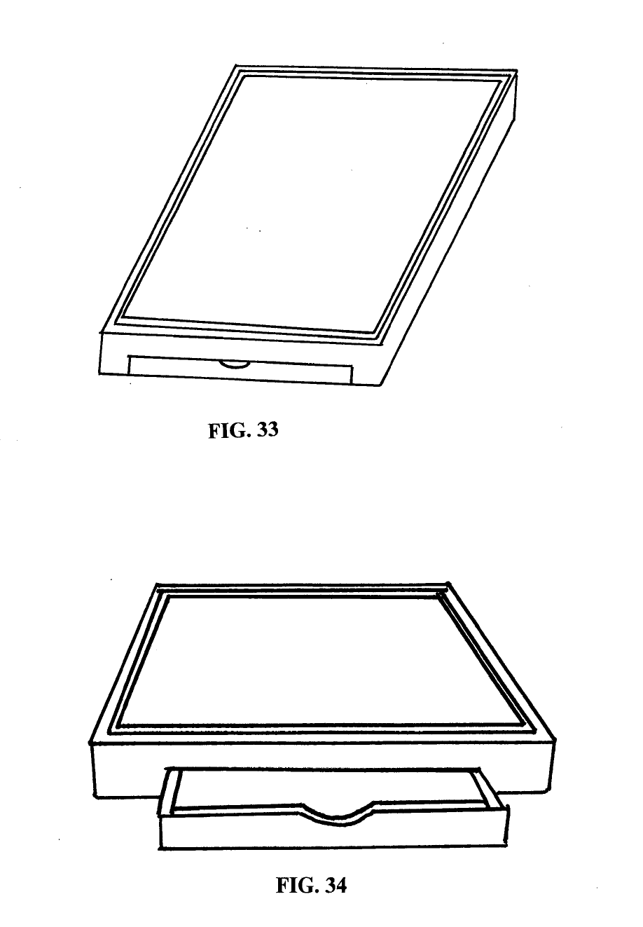

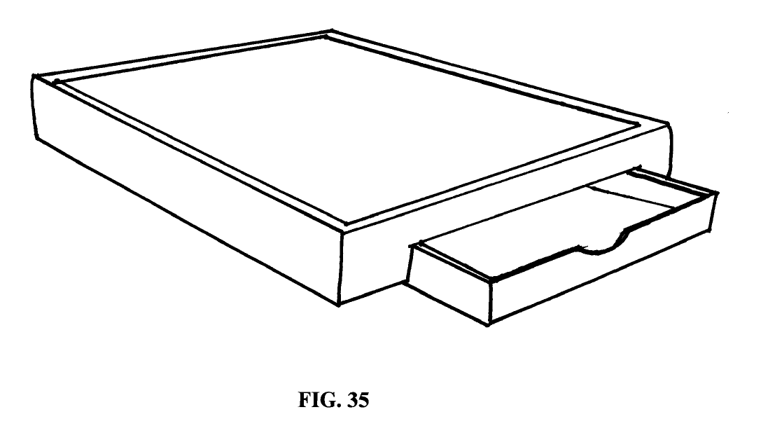

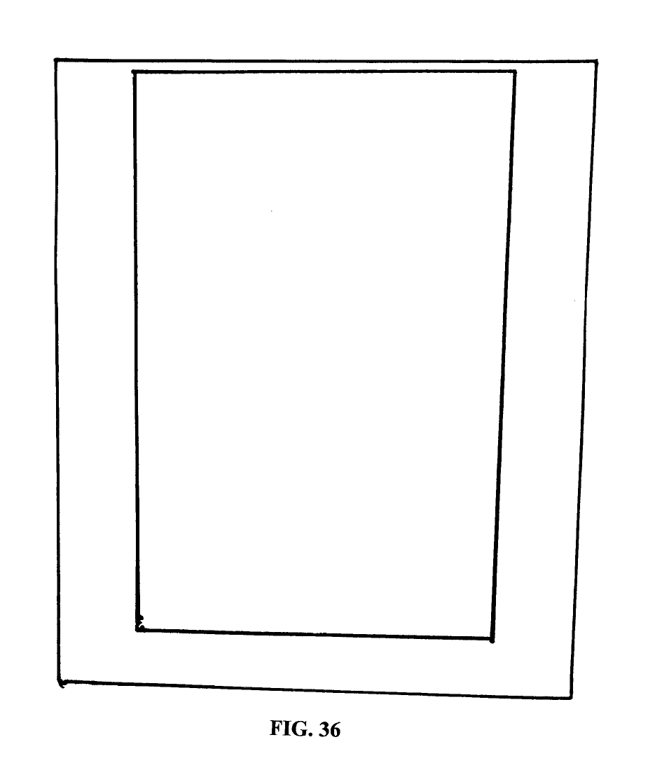

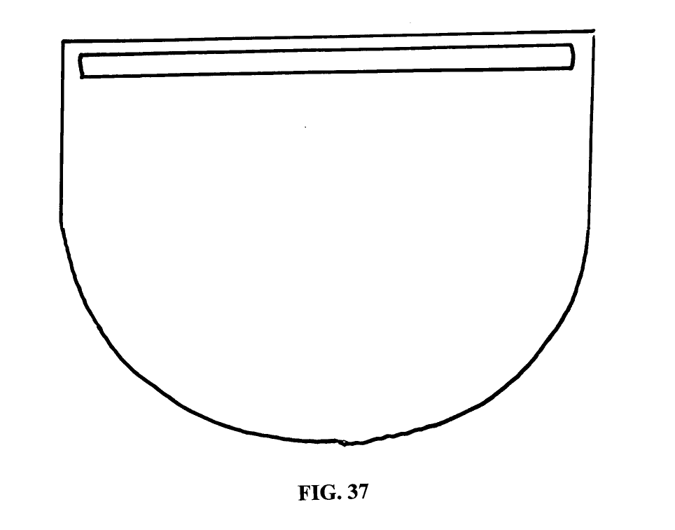

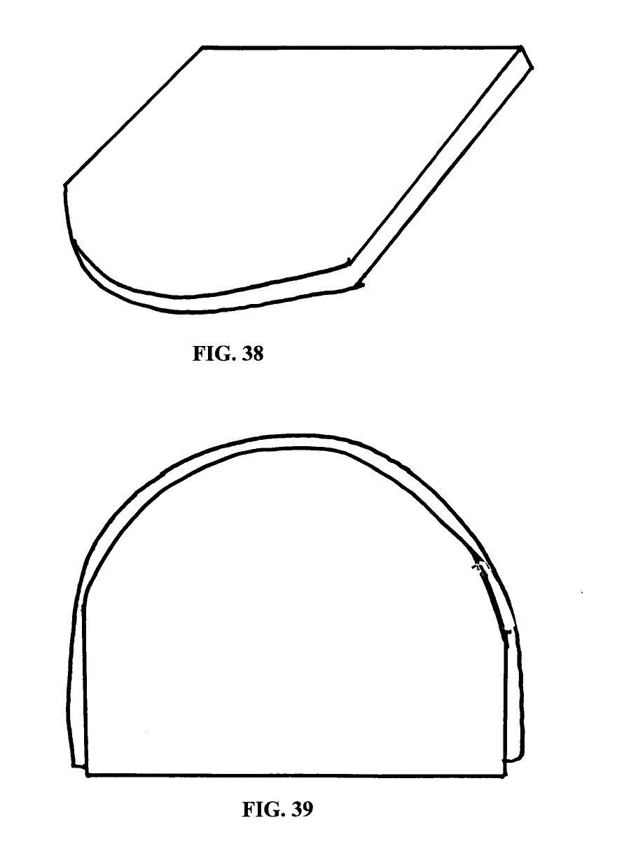

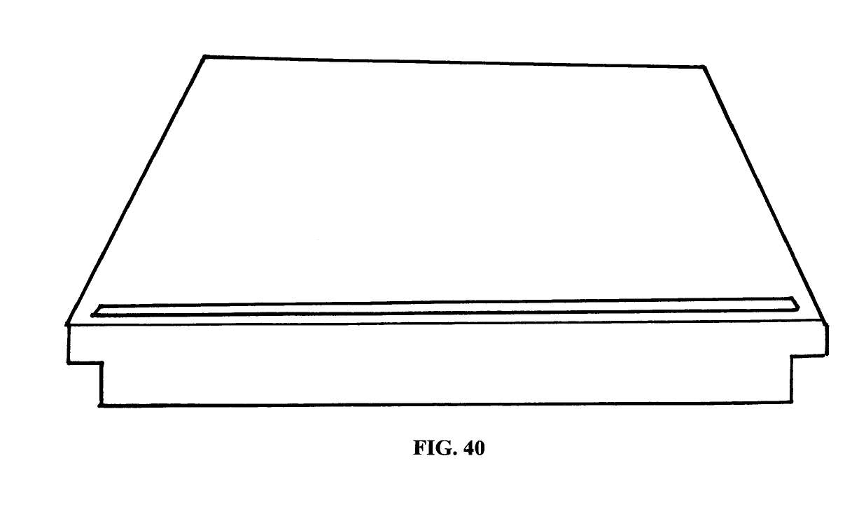

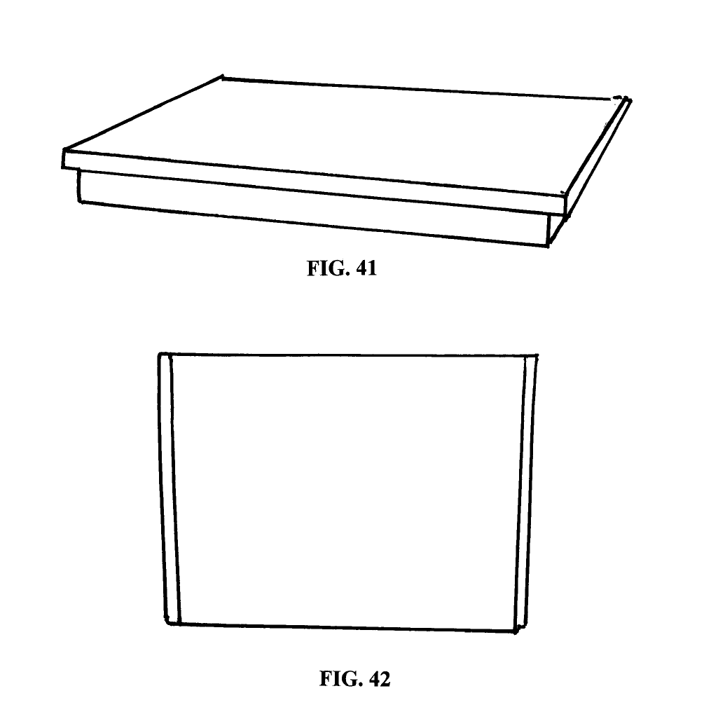

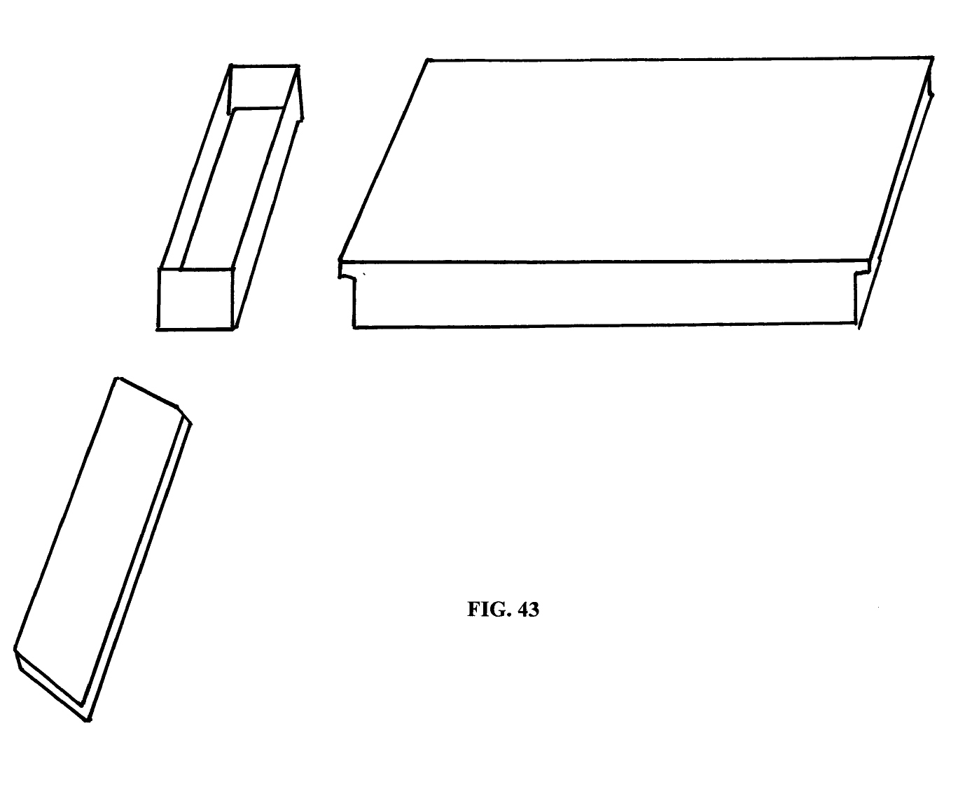

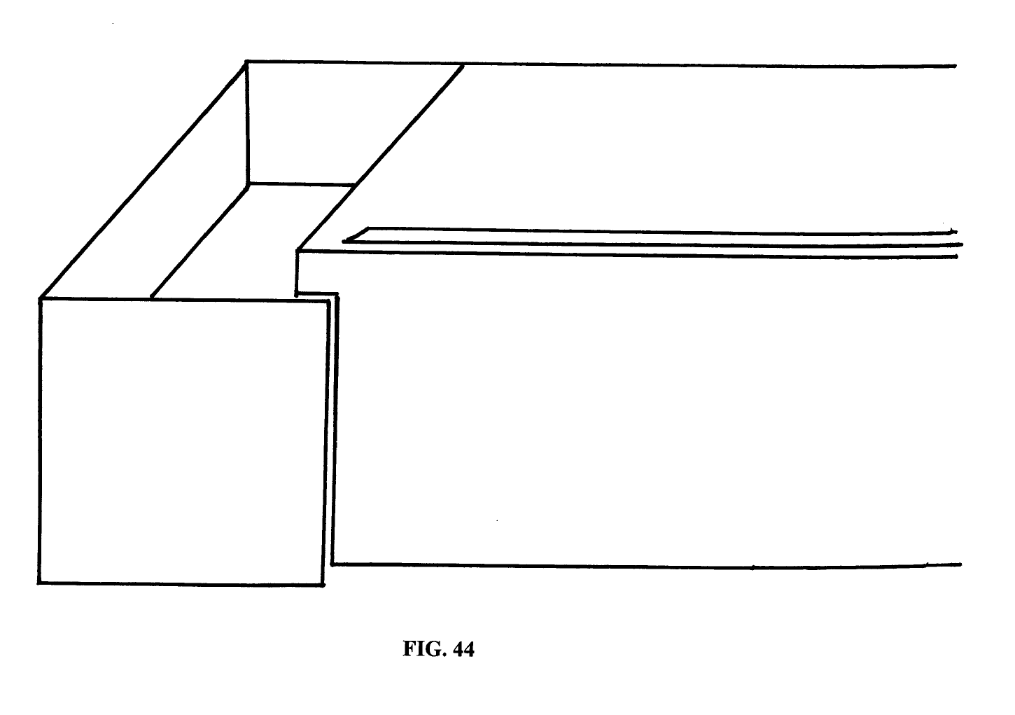

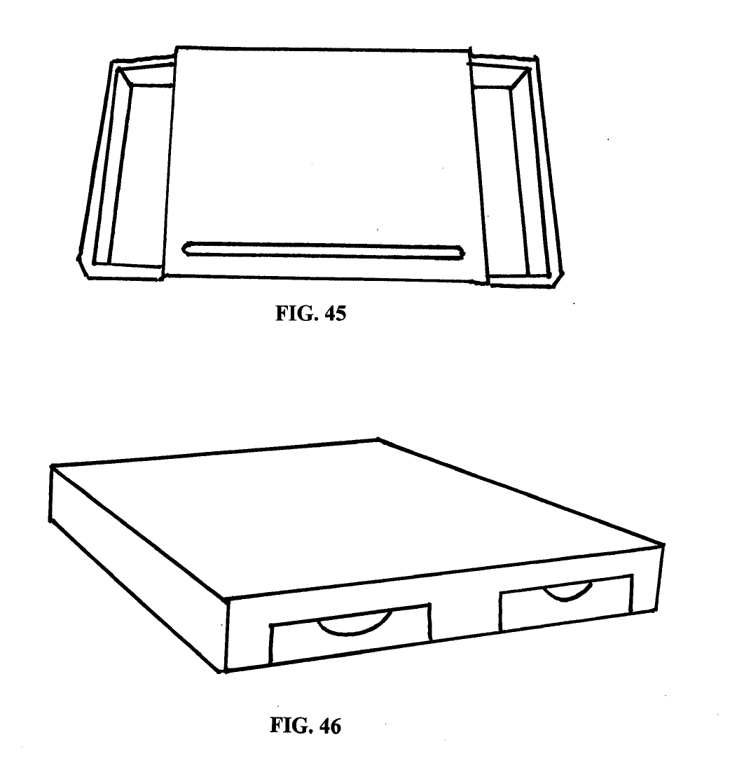

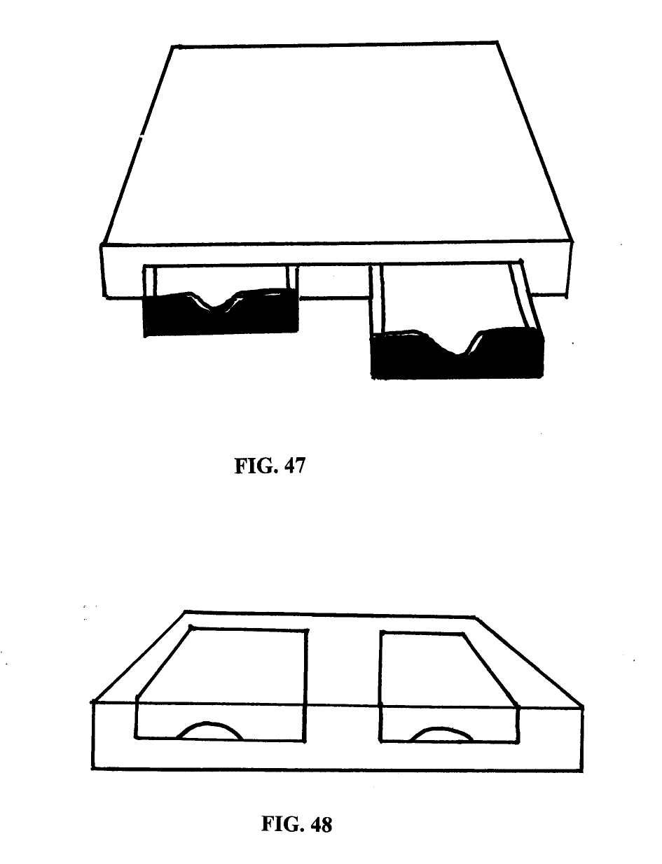

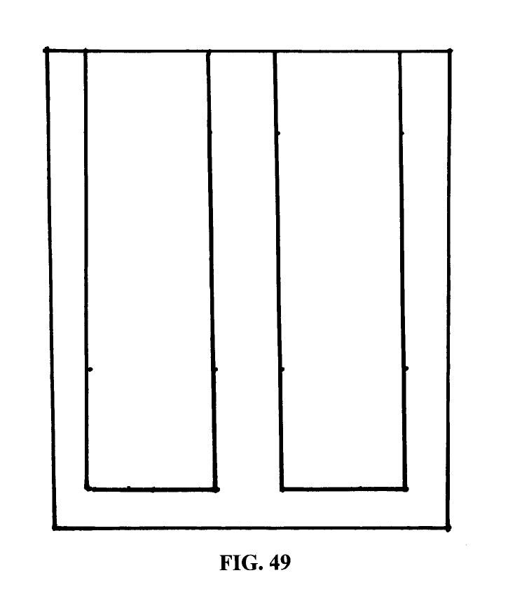

FIG. 31 shows another exemplary cutting board of the invention, where the cutting surface (210) extends to a ridge (211) over the back portion (214) of the cutting board. Legs (212) are visible. FIG. 31B also shows an optional groove (213) for holding excess liquid during food processing. FIG. 31C shows a side view of the cutting board.

In conclusion, herein is presented a combination of cutting board, storage box, cutting board holders, and removable trays. The invention is illustrated by example in the drawing figures, and throughout the written description. It should be understood that numerous variations are possible, while adhering to the inventive concept. Such variations are contemplated as being a part of the present invention.

Although the invention has been described with reference to the above example, it will be understood that modifications and variations are encompassed within the spirit and scope of the invention. Accordingly, the invention is limited only by the following claims.

What is claimed is:

1. A food preparation device comprising one main unit and a plurality of removable food containment trays, wherein:
the main unit comprises a flat cutting surface, a front edge and a back edge, and a plurality of magnets; and
each of the removable food containment trays comprises a metal plate;
wherein the removable food containment trays are secured to the main unit via a magnet-metal plate interaction.

2. The device of claim 1, wherein the main unit further comprises a groove on the cutting surface proximate to the front edge.

3. The device of claim 1, wherein the main unit further comprises two grooves on the cutting surface, wherein one groove is proximate to the front edge and the other groove is proximate to the back edge.

4. The device of claim 1, wherein the device comprises two removable food containment trays.

5. The device of claim 1, wherein the device comprises four removable food containment trays.

6. The device of claim 1, wherein the main unit further comprises at least one handle.

7. The device of claim 1, further comprises at least one knife drawer or food drawer.

8. The device of claim 7, wherein the knife drawer or food drawer comprises at least one magnet or magnetic plate.

9. The device of claim 7, wherein the knife drawer or food drawer comprises a plurality of reverse grooves or rails.

10. The device of claim 7, wherein the knife drawer or food drawer comprises a handle.

11. The device of claim 1, further comprising a cutting board holder, wherein the cutting board holder comprises two vertical surfaces and one horizontal surface.

12. The device of claim 11, wherein the cutting board holder is mounted on a wall, a door, or a cabinet door.

13. The device of claim 11, wherein the cutting board holder comprises at least four holes on one of the vertical surfaces.

14. A cutting board holder comprising one large flat surface, one small flat surface, and a bottom surface.

15. The cutting board holder of claim 14, wherein both the large flat surface and the small flat surface are connected to the bottom surface.

16. The cutting board holder of claim 14, wherein the cutting board holder is mounted on a wall or inside a pantry door.

17. A food preparation device comprising one main unit and at least one removable food containment tray, wherein:
the main unit comprises a flat cutting surface, a front portion and a back portion, and a plurality of magnets, magnet plates, or metal plates; and
each removable food containment tray comprises a magnet, metal plate, or magnetic plate, and optional comprises a lid to cover storing space;
wherein each removable food containment tray is secured to the main unit via a magnet-metal plate interaction.

18. The device of claim 17, wherein the main unit further comprises a groove on the cutting surface proximate to the front portion.

19. The device of claim 17, wherein the main unit further comprises two grooves on the cutting surface, wherein one groove is proximate to the front portion and the other groove is proximate to the back portion.

20. The device of claim 17, wherein the device comprises two removable food containment trays.
